(19) United States
(12) Patent Application Publication
(10) Pub. No.: US 2026/0348291 A1
(43) Pub. Date: Nov. 5, 2026

(54) ADDITIVE LAYER MANUFACTURING ENABLED INTEGRAL STRIP SEAL FOR TURBINE VANES

(71) Applicant: Rolls-Royce North American Technologies Inc., Indianapolis, IN (US)

(72) Inventors: Michel S. Smallwood, Indianapolis, IN (US); Andrew M. Simonich, Indianapolis, IN (US); Rex M. Little, Indianapolis, IN (US); Lawrence Langford, Indianapolis, IN (US)

(21) Appl. No.: 19/195,694

(22) Filed: Apr. 30, 2025

(51) Int. Cl. F01D 11/00; F01D 9/04

(52) U.S. Cl. CPC F01D 11/003; F01D 9/041; F05D 2240/55; F05D 2240/80

(57) ABSTRACT

A gas turbine engine includes first and second vane assemblies arranged adjacent to each other, each vane assembly including a vane platform including a groove formed in a side wall that faces the opposing vane assembly. The engine further includes a seal arranged between the first and second vane platforms that extends circumferentially, the seal having a first end arranged in the groove of the first vane assembly and a second end arranged in the groove of the second vane assembly. The seal includes a main body extending between the opposing vane platforms and a projecting portion arranged within a corresponding projection receiving recess formed in one of the grooves so as to allow for thermal expansion of the vane assemblies while delimiting movement of vane assemblies away from each other. The vane assemblies and the seal are formed in a single fabrication operation.

### STATEMENT REGARDING FEDERALLY SPONSORED RESEARCH OR DEVELOPMENT

Embodiments of the present disclosure were made with government support under Purchase Order No. 5100009513 in support of Agreement No. HQ00342090012. The government may have certain rights.

### FIELD OF THE DISCLOSURE

The present disclosure relates generally to gas turbine engines, and in particular, to components of gas turbine engines that can be formed via additive layer manufacturing processes.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high-pressure air and is ignited. Products of the combustion reaction in the combustor are directed into the turbine where work is extracted by rows of rotating blades and non-rotating vanes to drive the compressor and, sometimes, an output shaft. Each blade and vane has an airfoil that interacts with gases as they pass through the engine.

Construction and assembly of gas turbine engine components can present many challenges due to the great complexity of the components and the assembly process of these components. Engine components must be manufactured with the utmost precision to ensure the engine is assembled as accurate to design as possible, as well as to ensure smooth and safe operation of the engine.

### SUMMARY

The present disclosure may comprise one or more of the following features and combinations thereof.

According to a first aspect of the present disclosure, a gas turbine engine includes a first vane assembly including a first vane platform extending circumferentially about a central axis of the gas turbine engine and a first vane extending radially away from the first vane platform and configured to interact with gases flowing through the gas turbine engine, the first vane platform including a first groove formed in a first circumferentially-facing side wall of the first vane platform that opens in a first circumferential direction, a second vane assembly arranged circumferentially adjacent to the first vane assembly and including a second vane platform extending circumferentially about the central axis and a second vane extending radially away from the second vane platform and configured to interact with the gases flowing through the gas turbine engine, the second vane platform including a second groove formed in a second circumferentially-facing side wall of the first vane platform that opens in a second circumferential direction opposite the first circumferential direction, and a first seal arranged between the first and second vane platforms that extends circumferentially, the first seal having a first end arranged in the first groove and a second end arranged in the second groove, the first seal configured to block the gases flowing over the first and second vanes from passing through a circumferential gap between the first and second vane platforms.

In some embodiments, the first seal includes a main body extending between the first and second vane platforms and a first projecting portion arranged within a corresponding first projection receiving recess formed in one of the first and second grooves so as to allow for thermal expansion of the first and second vane assemblies while delimiting movement of first and second vane assemblies circumferentially away from each other, and the first vane assembly, the second vane assembly, and the first seal are formed in a single fabrication operation.

In some embodiments, the first vane assembly, the second vane assembly, and the first seal are formed integrally as a single, monolithic component via additive layer manufacturing.

In some embodiments, the first projecting portion is spaced apart from an inner surface of the first projection receiving recess in a neutral position of the first seal so as to allow the first and second vane assemblies to move circumferentially toward each other, and, in response to the first and second vane assemblies moving circumferentially away from each other, the first projecting portion engages the inner surface so as to delimit movement of first and second vane assemblies circumferentially away from each other.

In some embodiments, the first projecting portion includes a first projection surface that faces at least partially in the first circumferential direction and a second projection surface that faces at least partially in the second circumferential direction, and the inner surface of the first projection receiving recess includes a first inner surface adjacent to and spaced apart from the first projection surface and a second inner surface adjacent to and spaced apart from the second projection surface in the neutral position of the first seal.

In some embodiments, in response to movement of the first and second vane assemblies circumferentially away from each other, the first projection surface engages the first inner surface so as to delimit movement of the first and second vane assemblies circumferentially away from each other, and, in response to movement of the first and second vane assemblies circumferentially toward each other during thermal expansion of the first and second vane assemblies, the second projection surface moves toward the second inner surface and the first projection surface moves away from the first inner surface so as to allow for movement of the first and second vane assemblies circumferentially toward each other.

In some embodiments, the main body of the first seal has a first end on which the first projecting portion is arranged and a second end opposite the first end, and first seal further includes a second projecting portion arranged on the second end of the main body.

In some embodiments, the second projecting portion is arranged within a second projection receiving recess formed in the other of the first and second grooves.

In some embodiments, the first and second projecting portions each include an annular portion, the first and second projection receiving recesses each include an annular portion corresponding to the annular portions of the first and second projecting portions arranged therein, an outer surface of each annular portion of the first and second projecting portions is spaced apart from an inner surface of the annular portion of the respective projection receiving recess in a neutral position of the first seal so as to allow the first and second vane assemblies to move circumferentially toward each other, and, in response to the first and second vane assemblies moving circumferentially away from each other, the outer surface of each annular portion of the first and second projecting portions engages the inner surface of the annular portion of the respective projection receiving recess so as to delimit movement of first and second vane assemblies circumferentially away from each other.

In some embodiments, the first and second projecting portions each include at least one first radially projecting portion extending radially inwardly, the first and second projection receiving recesses each include at least one second radially projecting portion circumferentially offset from the at least one first radially projecting portion in a circumferential direction toward the opposing vane assembly and extending radially outwardly, the at least one first radially projecting portion is circumferentially spaced apart from the at least one second radially projecting portion in a neutral position of the first seal so as to allow the first and second vane assemblies to move circumferentially toward each other, and, in response to the first and second vane assemblies moving circumferentially away from each other, the at least one first radially projecting portion engages the at least one second radially projecting portion so as to delimit movement of first and second vane assemblies circumferentially away from each other.

In some embodiments, the main body of the first seal is formed at least partially as a spring configured to expand and contract during thermal expansion of the first and second vane assemblies.

According to a further aspect of the present disclosure, a first engine component configured to interact with gases flowing through the gas turbine engine and a second engine component arranged adjacent to the first engine component and configured to interact with the gases flowing through the gas turbine engine, at least one of the first and second engine components includes a first groove formed in a first surface facing the other of the first and second engine components, and a first seal arranged between the first and second engine components, the first seal having a first end arranged in the first groove and a second end located outside of the first groove, the first seal configured to block the gases flowing over the first and second engine components from passing through a gap between the first and second engine components.

In some embodiments, the first seal includes a main body extending between the first and second engine components and a first projecting portion arranged within a corresponding first projection receiving recess formed in the first groove so as to allow for thermal expansion of the first and second engine components, and the first engine component, the second engine component, and the first seal are formed in a single fabrication operation.

In some embodiments, the first engine component, the second engine component, and the first seal are formed integrally as a single, monolithic component via additive layer manufacturing.

In some embodiments, the first projecting portion is spaced apart from an inner surface of the first projection receiving recess in a neutral position of the first seal so as to allow the first and second engine components to move circumferentially toward each other, and, in response to the first and second engine components moving circumferentially away from each other, the first projecting portion engages the inner surface so as to delimit movement of first and second engine components circumferentially away from each other.

In some embodiments, the first engine component includes the first groove formed in the first surface facing the second engine component and the second engine component includes a second groove formed in a second surface facing the first engine component, and the second end of the of the first seal is arranged in the second groove.

In some embodiments, the first seal further includes a second projecting portion opposite the first projection portion and arranged within a corresponding second projection receiving recess formed in the second groove so as to allow for thermal expansion of the first and second engine components.

In some embodiments, the first engine component includes the first groove formed in the first surface facing the second engine component, the second end is coupled to and extends away from a second surface of the second engine component facing the first engine component, the main body includes a radially outer surface and a radially inner surface that are each parallel to a circumferential direction and that extend from the second end to first projecting portion.

According to a further aspect of the present disclosure, a method includes additively manufacturing a first engine component of a gas turbine engine, a second engine component of the gas turbine engine arranged adjacent to the first engine component, and a first seal arranged between the first and second engine components such that the first and second engine components and the first seal are formed in a single fabrication operation. The additive manufacturing of the first and second engine components and the first seal can include forming a first groove in the first engine component in a first side wall of the first engine component that opens toward the second engine component, forming a second groove in the second engine component in a second side wall of the second engine component that opens toward the first engine component, and forming a first end of the first seal in the first groove and a second end of the first seal opposite the first end in the second groove.

In some embodiments, the first seal includes a main body extending between the first and second engine components and a first projecting portion arranged within a corresponding first projection receiving recess formed in one of the first and second grooves so as to allow for thermal expansion of the first and second engine components while delimiting movement of first and second vane engine components away from each other.

In some embodiments, the first projecting portion is additively manufactured so as to be spaced apart from an inner surface of the first projection receiving recess in a neutral position of the first seal so as to allow the first and second engine components to move toward each other, and, in response to the first and second engine components moving away from each other, the first projecting portion engages the inner surface so as to delimit movement of first and second engine components away from each other.

In some embodiments, the method further includes determining distances that the first and second engine components can move relative to each other due to one or more of thermal expansion or thermal contraction when arranged in the gas turbine engine and subject to thermal stresses, and additively manufacturing the first projection receiving recess such that a distance between the inner surface of the first projection receiving recess and the first projecting portion allows the first and second engine components to move the determined distances during thermal expansion of the first and second engine components.

In some embodiments, the first and second engine components are circumferentially spaced apart from each other, the first projecting portion includes a first projection surface that faces at least partially in a first circumferential direction and a second projection surface that faces at least partially in a second circumferential direction opposite the first circumferential direction, the inner surface of the first projection receiving recess includes a first inner surface adjacent to and spaced apart from the first projection surface and a second inner surface adjacent to and spaced apart from the second projection surface in the neutral position of the first seal, and the circumferential distances include a distance between the first projection surface and the first inner surface and a distance between the second projection surface and the second inner surface.

These and other features of the present disclosure will become more apparent from the following description of the illustrative embodiments.

### BRIEF DESCRIPTION OF THE DRAWINGS

FIG. 1 is a cutaway view of a gas turbine engine that includes a fan, a compressor, a combustor, and a turbine, the fan including a fan rotor configured to rotate about a central axis of the engine, and showing that the turbine can include an annular vane ring having multiple vane assemblies circumferentially adjacent to each other and at least one seal arranged between the assemblies, the annular vane ring being formed via additive layer manufacturing;

FIG. 2 is an axially-facing cross-sectional view taken along line 2-2 in FIG. 4 showing two circumferentially adjacent vane assemblies of the vane ring of FIG. 1, showing that each vane assembly includes a groove formed in a circumferentially-facing side wall, and showing that a first seal is arranged within each groove, each end of the first seal including a projecting portion arranged within corresponding projection receiving recesses formed in the grooves;

FIG. 3 is a front view of the vane ring of FIG. 1, showing the vane assemblies arranged circumferentially adjacent to each other in an annular fashion to create the annular vane ring, each vane assembly including two vanes extending between an inner vane platform and an outer vane platform, the first seals being arranged within circumferential gaps defined between the inner vane platforms and/or the outer vane platforms;

FIG. 4 is a radially-facing cross-sectional view taken along line 4-4 of FIG. 2 showing the two vane assemblies and first seal of FIG. 2, showing the axial extent of the grooves in which the first seal is arranged;

FIG. 5 is an axially-facing cross-sectional view of the vane assemblies and first seal of FIG. 2, showing the position of the vane assemblies after they have moved circumferentially toward each other due to thermal expansion of the vane assemblies;

FIG. 6 is an axially-facing cross-sectional view of the vane assemblies and first seal of FIG. 2, showing the position of the vane assemblies after they have moved circumferentially away from each other, which may be caused due to thermal contraction of the vane assemblies;

FIG. 7 is an axially-facing cross-sectional view of the vane assemblies and first seal of FIG. 2, showing the layers of additive material that have been successively constructed via the additive layer manufacturing process and method described herein;

FIG. 8 is an axially-facing cross-sectional view of vane assemblies and a first seal according to a further aspect of the present disclosure, showing that the first seal includes projection portions at each end of the seal, the projecting portions being formed in an alternating radially-outwardly extending and radially-inwardly extending shape known colloquially as a zig-zag pattern; and showing that the first seal can include a spring between the projecting portions along a main body of the seal;

FIG. 9 is an axially-facing cross-sectional view of the vane assemblies of FIG. 8, showing an alternative arrangement of the spring arranged between the projecting portions;

FIG. 10 is an axially-facing cross-sectional view of vane assemblies and a first seal according to a further aspect of the present disclosure, showing that the first seal includes multiple projecting portions at each end of the seal, the projecting portions extending radially inwardly into corresponding protrusion receiving recesses formed in the grooves and creating a knife edge similar to a labyrinth seal;

FIG. 11 is an axially-facing cross-sectional view of the vane assemblies of FIG. 10, showing the first seal having been moved radially inwardly due to differential pressure of the gases on opposing radial sides of the vane assemblies, and showing that the tips of the radially-extending protrusions contact radially inner surfaces of the protrusion receiving recesses to create a seal;

FIG. 12A is an axially-facing cross-sectional view of the vane assemblies of FIG. 10, showing an alternative arrangement of the protrusion receiving recesses, in particular showing that the grooves include a single protrusion receiving recess that receives a plurality of the radially-extending protrusions;

FIG. 12B is an axially-facing cross-sectional view of the vane assemblies of FIG. 10, showing an alternative arrangement of the protrusion receiving recesses, in particular showing that the projecting portions extend in both the radial outwardly and radially inwardly directions;

FIG. 13A is a radially-facing view of two circumferentially adjacent vane assemblies according to a further aspect of the present disclosure, showing that the vane assemblies can each include a groove having a projection receiving recess formed in the groove, the recesses extending in the circumferential direction in addition to the axial direction so as to receive projecting portions of the first seal that also extend in the circumferential direction, the engagement of the projecting portions with the projection receiving recesses delimiting movement of the first seal in the axial direction;

FIG. 13B is a circumferentially-facing view of one of the vane assemblies of FIG. 13A, showing that the projecting portions of the first seal and the projection receiving recesses of the vane assemblies can be formed similarly to the axially-extending projecting portions and the projection receiving recesses of the first seal shown in FIG. 2;

FIG. 13C is a circumferentially-facing view of an alternative arrangement of one of the vane assemblies and the first seal of FIG. 13B, showing that, as opposed to having two projecting portions, the first seal can include no projecting portions and the groove can include an axially-facing open end such that the first seal can be removed and replaced via the open end;

FIG. 13D is a radially-facing view of two circumferentially adjacent vane assemblies similar to the vane assemblies shown in FIG. 13A, showing that the vane assemblies can each include a groove having a projection receiving recess formed in the groove, the recesses extending in the circumferential direction in addition to the axial direction so as to receive projecting portions of the first seal that also extend in the circumferential direction, and showing the first seal can include a protruding support configured to support the seal;

FIG. 14 is an axially-facing cross-sectional view of vane assemblies and a first seal according to a further aspect of the present disclosure, showing that the protrusion-receiving recesses can be formed larger than those shown in FIG. 2 to allow for additional circumferential movement of the vane assemblies relative to each other;

FIG. 15A is an axially-facing cross-sectional view of vane assemblies and a first seal according to a further aspect of the present disclosure, showing that the first seal can include one projecting portion on a first end of the seal that is arranged in a protrusion-receiving recess of a first vane assembly, and that the first seal can be coupled to the second vane assembly as opposed to being arranged in a groove formed in the second vane assembly;

FIG. 15B is an axially-facing cross-sectional view of the vane assemblies of FIG. 15A and an alternative first seal configured to be arranged in the groove formed in the first vane assembly, showing that the first seal includes a different projecting portion than the first seal of FIG. 15A;

FIG. 15C is an axially-facing cross-sectional view of the vane assemblies of FIG. 15A and an alternative first seal configured to be arranged in the groove formed in the first vane assembly, showing that the first seal includes a different projecting portion than the first seals of FIGS. 15A and 15B;

FIG. 16 is an axially-facing cross-sectional view of vane assemblies and a first seal according to a further aspect of the present disclosure, showing that the first seal can include multiple projecting portions on each end of a main body of the seal, each projecting portion being arranged in a corresponding projection-receiving recess formed in the respective groove of the vane assemblies;

FIG. 17A is an axially-facing cross-sectional view of vane assemblies and a first seal according to a further aspect of the present disclosure, showing that small obstructing members can be arranged in one of the grooves and extend between a radially inwardly-facing surface of the groove and a radially outwardly-facing surface of the first seal so as to create a tortuous path around the seal for the gases to flow over, showing that the protrusion-receiving recesses are formed similarly to those shown in FIG. 10, and showing that each obstructing member includes a sacrificial nub that can be removed in post-processing;

FIG. 17B is an axially-facing cross-sectional view of the vane assemblies and the first seal of FIG. 17A, showing the first seal after the sacrificial nubs have been removed;

FIG. 17C is an axially-facing cross-sectional view of an alternative arrangement of the vane assemblies and the first seal of FIG. 17A, showing that the protrusion-receiving recesses are formed similarly to those shown in FIG. 12A;

FIG. 17D is an axially-facing cross-sectional view of an alternative arrangement of the vane assemblies and the first seal of FIG. 17A, showing that the small obstructing members can be arranged in both grooves of the first and second vane assemblies;

FIG. 17E is a radially-facing view of the small obstructing members of the vane assemblies and first seal of FIGS. 17A-17D, showing the flow passages around the small obstructing members via which the gases can flow; and

FIG. 18 is a circumferentially-facing view of a vane assembly of the gas turbine engine of FIG. 1, showing that the first seals of the embodiments described herein can be arranged to extend radially in some embodiments in addition to being arranged to extend axially.

### DETAILED DESCRIPTION

For the purposes of promoting an understanding of the principles of the disclosure, reference will now be made to a number of illustrative embodiments illustrated in the drawings and specific language will be used to describe the same.

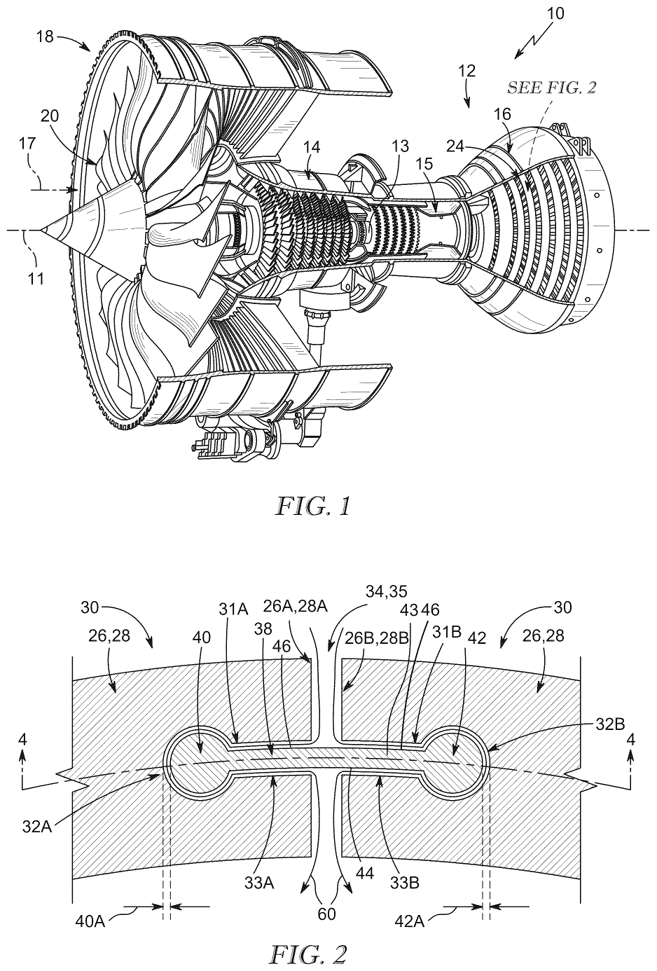

A gas turbine engine 10 in accordance with the present disclosure is shown in FIG. 1 and includes an engine core 12 and a fan 18 having a fan rotor 20 arranged upstream of the engine core 12. The engine core 12 is configured to compress and combust air 17 entering the gas turbine engine 10 to drive rotation of one or more shafts 13 about a rotation axis 11 of the gas turbine engine 10. The one or more shafts 13 interconnect the engine core 12 and the fan 18 to cause rotation of the fan rotor 20 and to provide thrust for the gas turbine engine 10.

The engine core 12 includes a compressor 14, a combustor 15, and a turbine 16. The compressor 14 includes one or more stages of rotating blades that compress air 17 entering the engine core 12 and produce pressurized air which is transferred downstream to the combustor 15. The combustor is configured to mix fuel with the pressurized air 17 and combust the fuel and pressurized air to produce combustion products which are transferred downstream to the turbine 16. The turbine 16 also includes one or more stages of rotating blades which are coupled to the one or more shafts 13 and are driven in rotation about the axis 11. Rotation of the one or more shafts 13 causes rotating components of the fan rotor 20 to rotate about the axis 11.

According to a first aspect of the present disclosure, turbine 16 can include an annular vane ring 24 arranged between stages of rotating blades of the turbine 16, the vane ring 24 being formed via additive layer manufacturing. By utilizing additive layer manufacturing to fabricate the vane ring 24, the vane ring 24 and its constituent components can be formed via a “single fabrication operation.” It is noted that references to additive layer manufacturing herein may also refer to “advanced manufacturing”.

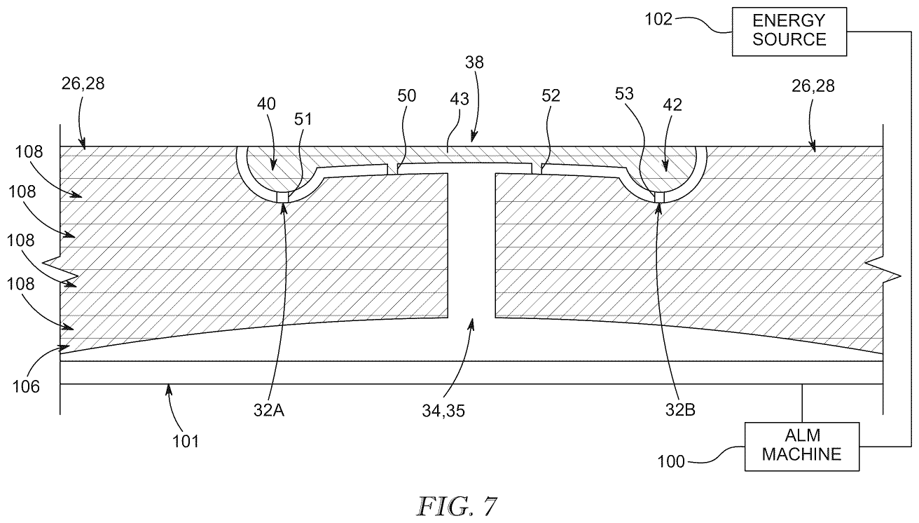

A single fabrication operation may refer to, in some non-limiting examples, as the vane ring 24 and its components (which can include the vane assemblies 30 and seal 38 described herein) being formed as a single, monolithic component in which all components of the ring 24 are connected to each other during the initial fabrication process. After the initial fabrication and during post-processing, components that are intended to be separate when the vane ring 24 is implemented in the gas turbine engine 10, such as the vane assemblies 30 and the first seal 38, may be separated from each other. Specifically, for example, sacrificial standoffs (i.e. standoffs 50, 51, 52, 53 shown in FIG. 7) that initially coupled all of the components together during the fabrication process may be removed so as to separate specific components.

A single fabrication operation may also refer to, in other non-limiting examples, as the vane ring 24 and its components (which can include the vane assemblies 30 and seal 38 described herein) being formed disconnected from each other, at least in some areas, during an uninterrupted, layer-by-layer fabrication process. For instance, in the exemplary fabrication steps shown in FIG. 7, the layers 108 can be formed without the standoffs 50, 51, 52, 53, and the portions of the layers 108 that form the loose, separate components (i.e. the vane assemblies 30 and the first seal 38) can be separated from each other and supported on each other via the additive layer powder, utilized for the additive layer manufacturing fabrication, being arranged in the regions between these separate components.

In many gas turbine engines, vane rings are formed in sections or segmented vane assemblies that are arranged circumferentially adjacent to each other in an annular fashion to create the vane ring 24. In order to block gases flowing through the turbine 16 through circumferential gaps formed between the segmented vane assemblies, the vane ring 24 can include seals arranged between the vane assemblies. According to the present disclosure, the entire vane ring 24 and its components can be formed in a single fabrication operation via additive layer manufacturing, which can lead to accurate dimensioning of each component, consistent and uniform production of multiple vane rings 24, ease of assembly, and high sealing performance.

Although reference is made to a vane ring 24 throughout the description, the present disclosure contemplates the application of the vane and seal assemblies and additive layer manufacturing of the same, as described herein, in other areas of the gas turbine engine 10. Accordingly, in some instances herein, the two adjacent components that include a seal therebetween may be referred to as “vane assemblies” while in other instances, may be referred to as “engine components.” By way of non-limiting examples, such engine components may further include exhaust nozzles, cassette combustors, infrared suppressors, vane supports, combustor to vane transitions, tailcones and the like. It is noted that the descriptions and illustrations of the vane and seal assemblies described herein are indicative of how such vane and seal assemblies would be applied in these exemplary alternative engine components, namely the descriptions and illustrations of two adjacent components and a seal extending therebetween.

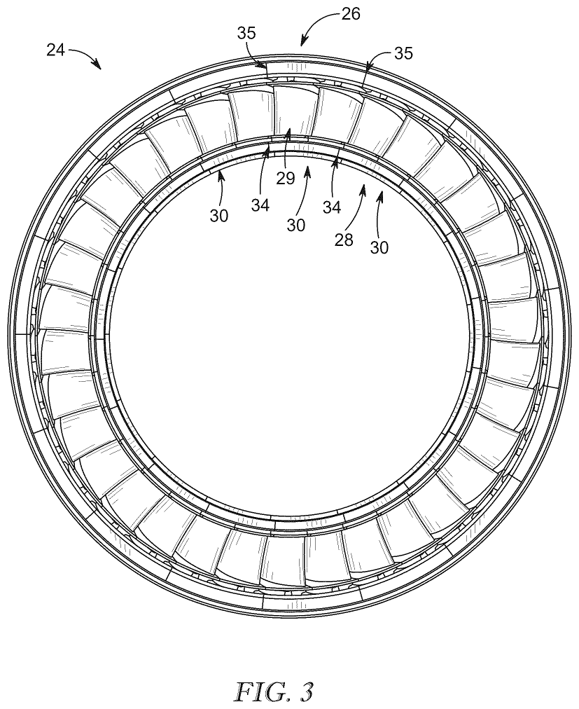

FIG. 3 shows an exemplary vane ring 24 which can be arranged within the turbine 16 of the engine 10, the vane ring 24 having been formed via additive layer manufacturing. As can be seen in FIG. 3, the vane ring 24 includes an outer vane platform 26, an inner vane platform 28, and a plurality of vanes 29 extending therebetween. The outer and inner vane platforms 26, 28 are formed in segments so as to define distinct vane assemblies 30 arranged circumferentially adjacent to each other in an annular fashion to create the annular vane ring 24. Illustratively, each vane assembly 30 includes two vanes 29 extending between a segmented outer vane platform 26 and a segmented inner vane platform 28, although more or fewer vanes 29 may be included on each vane assembly 30 based on the size of the vane ring 24 and/or the size of the engine 10.

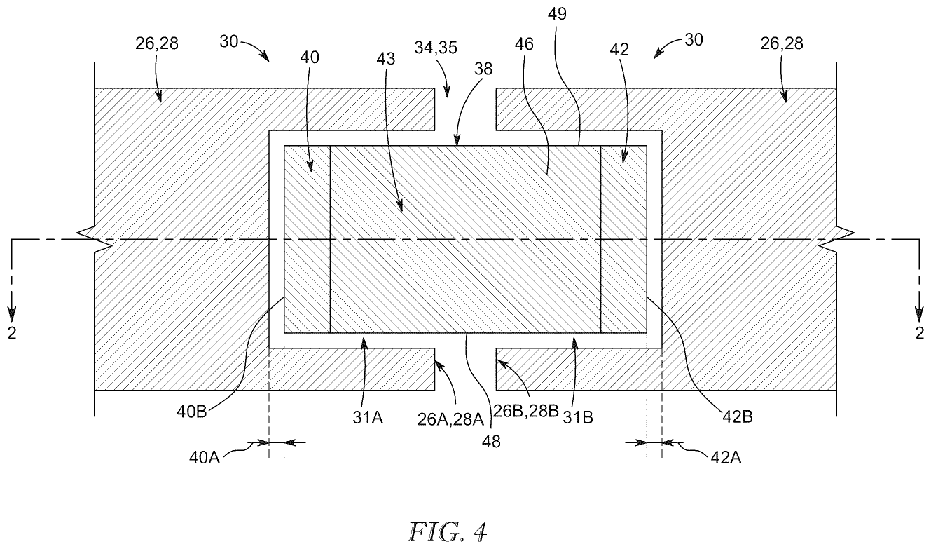

Because the vane assemblies 30 are formed as distinct segments, circumferential gaps 34, 35 are defined between the inner vane platforms 28 and the outer vane platforms 26, as shown in FIG. 3. In order to block gases flowing through the turbine 16 and over the vanes 30 of the vane ring 24 from escaping the flow path via these circumferential gaps 34, 35, a seal 38 can be arranged within one or more of the gaps 34, 35, a first embodiment of which can be seen in FIGS. 4-7. Although the entire vane ring 24 is formed via additive layer manufacturing as a single component, the vane assemblies 30 are nevertheless distinct from each other so as to allow for thermal expansion and movement of the assemblies 30 relative to each other. The seals 38 described herein are arranged within circumferentially interfacing sides of the vane assemblies 30 and are constructed or fabricated within the vane assemblies 30 during the additive layer manufacturing process, thus forming the entire vane ring 24 in a single fabrication operation while still allowing for the individual vane assemblies 30 to be distinct and movable relative to each other.

A first seal 38 according to a first aspect of the present disclosure is shown in FIG. 2. Because the first seal 38 can be arranged between one or more of the outer platforms 26 of the vane assemblies 30 and the inner platforms 28 of the vane assemblies 30 within the gaps 34, 35, the vane assemblies 30 within the seal 38 therebetween are illustrated with reference to both the inner and outer vane platforms 26, 28 and the respective gaps 34, 35. It is noted that the cross-hatching of the seals 38 is shown as different than the cross-hatching of the surrounding components (i.e. the inner and outer vane platforms 26, 28), not to indicate that the seal is formed of a different material that the surrounding components, but simply to illustrate that the seal 38 is separate from these components. In some embodiments, the seal 38 may be formed of a different material than the surrounding components (i.e. the inner and outer vane platforms 26, 28), via methods such as, for example, multi-material additive manufacturing.

As can be seen in FIG. 2, the inner and outer platforms 26, 28 of each vane assembly 30 include circumferentially-facing side walls 26A, 28A, 26B, 28B that face the respective circumferential direction. Specifically, a first vane assembly 30, which can be seen, for example, as the vane assembly 30 on the left of the illustration, may include a first circumferentially-facing side wall 26A, 28A that faces a first circumferential direction and a second vane assembly 30 arranged adjacent the first vane assembly 30, which can be seen, for example, as the vane assembly 30 on the right of the illustration, may include a second circumferentially-facing side wall 26B, 28B that faces a second circumferential direction opposite the first circumferential direction. The gap 34, 35 is defined between the first and second circumferentially-facing side walls 26A, 28A, 26B, 28B.

The first seal 38 can be formed via the additive layer manufacturing process described herein, in particular formed within the grooves 31A, 31B formed in the inner and/or outer platforms 26, 28, layer-by-layer, during the construction process of the vane assemblies 30. Accordingly, the seal can be formed having shapes that may, in some scenarios, may be challenging to manufacture and/or install via other manufacturing and assembly methods. Even further, more than one seal may be formed between adjacent engine components or vane assemblies 30 in some exemplary embodiments.

As can be seen in FIGS. 2 and 4, the first seal 38 can include a first end having a first projecting portion 40, a second end opposite the first end having a second projecting portion 42, and a main body 43 extending between the first and second projecting portions 40, 42. Although the first and second projecting portions 40, 42 are illustrated in the disclosed embodiment as being identical, as well as in the other embodiments disclosed herein, the first and second projecting portions 40, 42 may be formed to have different shapes and configurations so long as the projecting portions 40, 42 perform the functions of the seal 38 described herein.

Illustratively, the main body 43 is formed to be a relatively planar portion having a lower surface 44 and an upper surface 46 that are generally parallel with each other and extend circumferentially. The first seal 38 may extend axially from a forward side 48 to an aft side 49, as shown in FIG. 4. In some embodiments, the axially extent of the main body 43 and the projecting portions 40, 42 of the seal 38 is greater than the radial extent of the main body 43. In some embodiments, the axially extent of the main body 43 and the projecting portions 40, 42 of the seal 38 is greater than the radial extent of both the main body 43 and the projecting portions 40, 42, as can be seen in FIGS. 2 and 4. Moreover, as can be seen in FIG. 4, the sides 48, 49 may be spaced apart from the corresponding inner surfaces of the grooves 31A, 31B so as to allow for axial expansion and contraction of the vane assemblies 30.

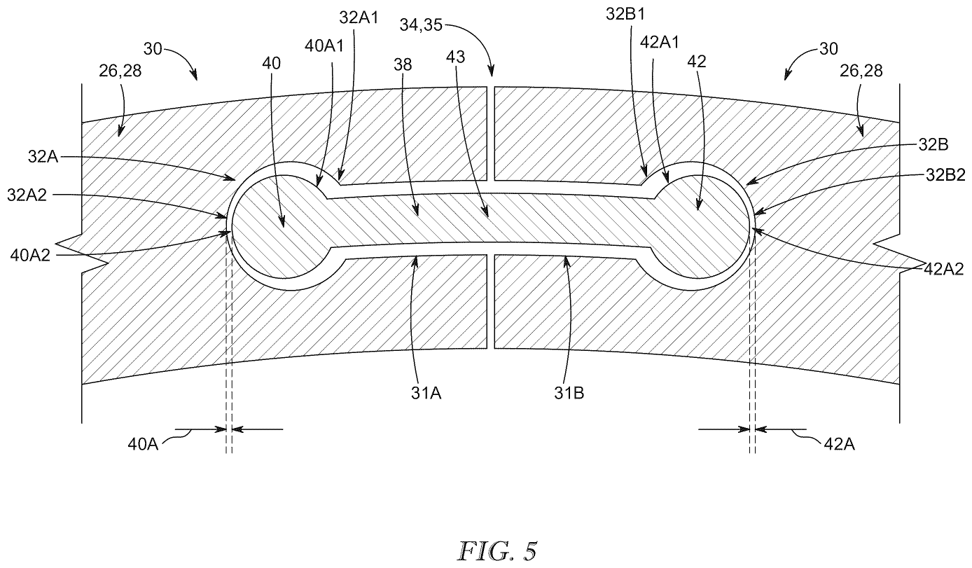

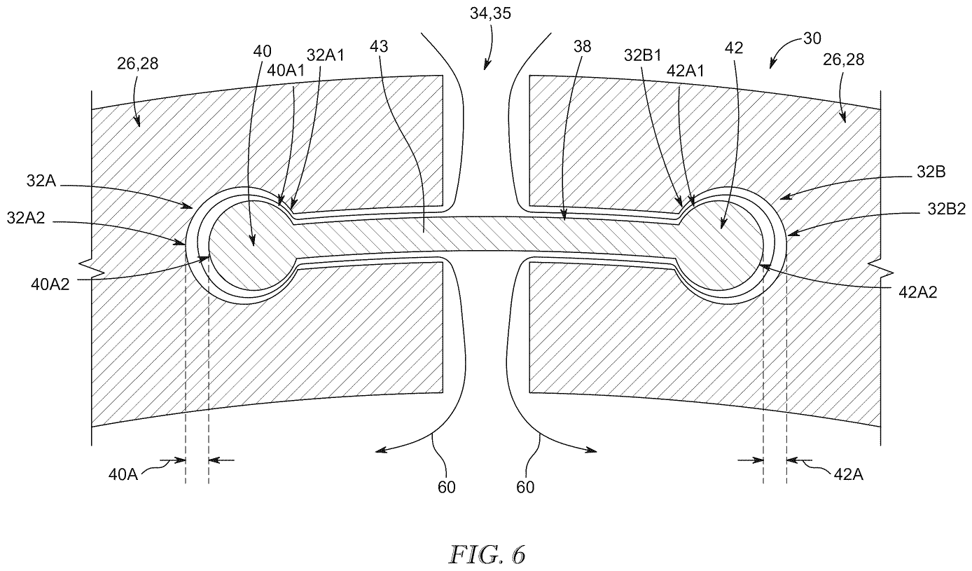

The projecting portions 40, 42 are formed to extend or protrude away from the first and second ends of the main body 43 of the first seal 38, as shown in FIG. 2. Illustratively, as can be seen in FIGS. 5 and 6, the projecting portions 40, 42 extend radially outwardly and inwardly so as to define outer surfaces 40A1, 42A1, 40A2, 42A2 that are configured to engage and move away from corresponding portions of the inner surfaces 32A1, 32B1, 32A2, 32B2 of the projection-receiving recesses 32A, 32B of the grooves 31A, 31B during thermal expansion or contraction of the vane assemblies 30 or other adjacent components which causes circumferential movement of the vane assemblies 30 relative to each other. Although the projecting portions 40, 42 are described as extending radially, the present disclosure also contemplates that at least a portion of or the entirety of the projecting portions 40, 42 may extend axially and engage and move away from corresponding inner surfaces of the projection-receiving recesses 32A, 32B to perform the same function of allowing for movement of the vane assemblies 30 relative to each other.

As shown in FIG. 2, the projecting portions 40, 42 are formed to have an annular cross-section that has a diameter that is larger than a radially-extending width of the main body 43 of the seal 38. In some embodiments, as shown in FIGS. 2 and 4, the projecting portions 40, 42 are formed to be cylindrical and extend axially along the axial extent of the main body 43. In some embodiments, the projecting portions 40, 42 may be formed to be cylindrical with spherical ends. Other shapes of the projecting portions 40, 42 are contemplated, so long as the projecting portions 40, 42 are formed to be larger than the radially-extending width of the main body 43.

To accommodate the main body 43 and projecting portions 40, 42 of the seal 38, the first vane assembly 30 includes the first groove 31A formed therein that opens outwardly at the first circumferentially-facing side wall 26A, 28A and the second vane assembly 30 includes a second groove 31B formed therein that opens outwardly at the second circumferentially-facing side wall 26B, 28B, as shown in FIG. 2. Each of the first and second grooves 31A, 31B includes a projection-receiving recess 32A, 32B and a main groove portion 33A, 33B that extends from the projection-receiving recess 32A, 32B to the circumferentially-facing side wall 26A, 28A, 26B, 28B.

Each projection-receiving recess 32A, 32B is formed to accommodate the projecting portions 40, 42 of the seal 38 therein. Illustratively, as shown in FIG. 2, the projection-receiving recess 32A, 32B is formed to have a shape commensurate with the shape of the respective projecting portion 40, 42, and in some embodiments, the shape of the projection-receiving recess 32A, 32B may match the shape of the respective projecting portion 40, 42. In one non-limiting example, the projection-receiving recesses 32A, 32B each have an annular shape that matches the annular shape of the projecting portions 40, 42.

As can be seen in FIGS. 2, 5 and 6, the projection-receiving recesses 32A, 32B are formed to be slightly larger than the projecting portions 40, 42 such that the outer surfaces 40A1, 42A1, 40A2, 42A2 of the projecting portions 40, 42 are spaced apart from the inner surfaces 32A1, 32B1, 32A2, 32B2 of the projection-receiving recesses 32A, 32B in a neutral position of the seal 38. The neutral position of the seal 38 may refer to a position in which the vane assemblies 30 have not yet moved relative to each other due to thermal expansion or contraction, a position that can be seen in FIG. 2. Similar to the spaced apart nature of the projection-receiving recesses 32A, 32B and the projecting portions 40, 42, the lower and upper surfaces 44, 46 of the main body 43 of the seal 38 may be spaced apart from the inner surfaces of the main groove portions 33A, 33B of the first and second grooves 31A, 31B, as shown in FIG. 2. Moreover, as can be seen in FIG. 2, outer sides of the seal 38 being spaced apart from the corresponding inner surfaces of the grooves 31A, 31B can allow for radial expansion and contraction of the vane assemblies 30.

As will be described in more detail below, the spaced apart nature of the main body 43 and the projecting portions 40, 42 and the grooves 31A, 31B, and in particular the spacing of the projecting portions 40, 42 and the projection-receiving recesses 32A, 32B, further allows for circumferential movement of the vane assemblies 30 relative to each other, for example, during thermal expansion or contraction of the vane assemblies 30. This spacing also provides a gas flow path 60 that extends around the seal 38 in the space between the grooves 31A, 31B and the seal 38. It is noted that, although show the gas flow path 60 extending in a general direction through gap 34, 35 between adjacent outer vane platforms 26 (i.e. flowing radially inwardly), this flow would be reversed if the flow path 60 were passing between adjacent inner vane platforms 28 (i.e. flowing radially outwardly).

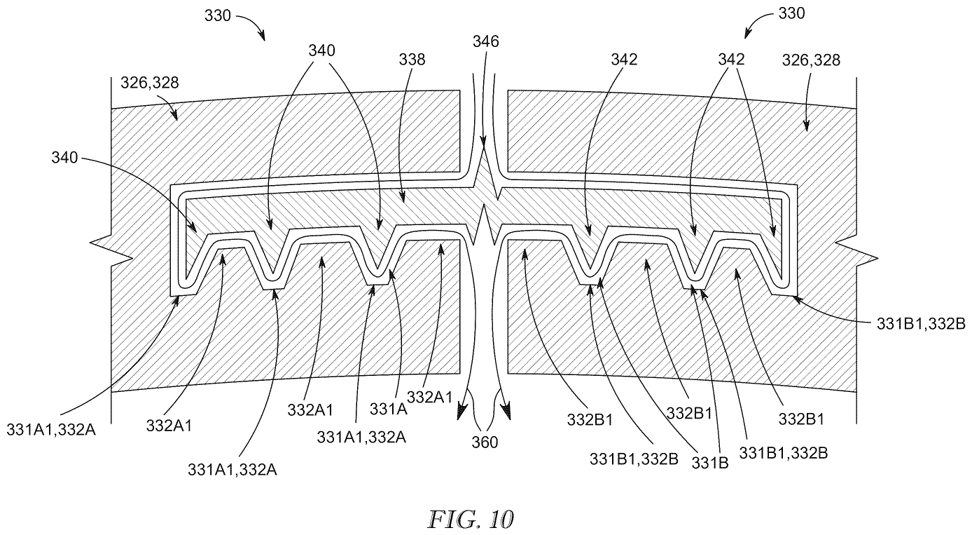

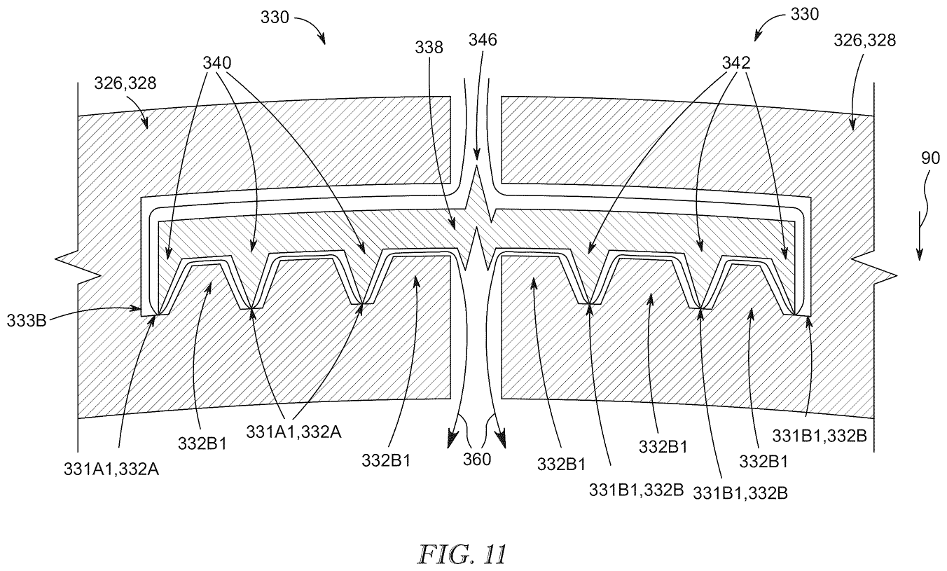

The gas flow path 60 around the seal 38 can be altered based on the movement of the seal 38 within the grooves 31A, 31B. For example, a small amount of the gases may be able to pass through the gap 34, 35 when the seal 38 is in the neutral position shown in FIG. 2, while a smaller amount of the gases may be able to pass through the gap 34, 35 when the vane assemblies 30 move toward each other (FIG. 5) or move away from each other (FIG. 6) since portions of the outer surfaces 40A1, 42A1, 40A2, 42A2 of the projecting portions 40, 42 are contacting portions of the inner surfaces 32A1, 32B1, 32A2, 32B2 of the projection-receiving recesses 32A, 32B and thus largely cutting off the flow path 60 therebetween. Moreover, differential pressure on opposing sides of the vane platform 26, 28 may cause the seal 38 to move to one of the radial sides of the grooves 31A, 31B (see, e.g., FIG. 10, which shows how the seal 338 is moved radially inwardly (direction 90) due to differential pressure on opposing sides of the vane platform 326, 328). This may also cut off a portion of the flow path 60 along portions of the seal 38 that contact the inner surface of the grooves 31A, 31B.

Turning back to the movement between adjacent vane assemblies 30, FIGS. 5 and 6 show the vane assemblies 30 after they have moved toward and away from each other, respectively. As described above, the projecting portions 40, 42 are spaced apart from the inner surfaces 32A1, 32B1, 32A2, 32B2 of the projection-receiving recesses 32A, 32B in a neutral position of the first seal 38. In some embodiments, each projecting portion 40, 42 can include a first projection surface 40A1, 42A1 that faces at least partially in the first circumferential direction and a second projection surface 40A2, 42A2 that at least partially faces in the second circumferential direction. As can be seen in FIGS. 2 and 4-6, the first projection surface 40A1, 42A1 can be located on one side of the annular cross-section of the projecting portions 40, 42 and the second projection surface 40A2, 42A2 can be located on the other side of the annular cross-section of the projecting portions 40, 42. Similarly, the inner surfaces of the projection-receiving recesses 32A, 32B include first inner surfaces 32A1, 32B1 adjacent to the first projection surfaces 40A1, 42A1 and second inner surfaces 32A2, 32B2 adjacent to the second projection surfaces 40A2, 42A2.

As can be seen in FIGS. 2, 5, and 6, the distance between the surfaces 40A1, 42A1, 40A2, 42A2 of the projecting portions 40, 42 and the adjacent inner surfaces 32A1, 32B1, 32A2, 32B2 is proportional to the allowable circumferential movement distance of the vane assemblies 30 relative to each other. For example, FIG. 2 shows the distance 40A, 42A between the second projection surfaces 40A2, 42A2 and the second inner surfaces 32A2, 32B2 in the neutral position of the vane assemblies 30. FIG. 5 shows that the second projection surfaces 40A2, 42A2 have moved toward the second inner surfaces 32A2, 32B2 such that the distance 40A, 42A is much smaller, and the difference between the distance 40A, 42A shown in FIG. 2 and the distance 40A, 42A shown in FIG. 5 is equal to the distance that the vane assemblies 30 moved toward each other. Similarly, FIG. 6 shows that the second projection surfaces 40A2, 42A2 have moved away the second inner surfaces 32A2, 32B2 such that the distance 40A, 42A is much larger, and the difference between the distance 40A, 42A shown in FIG. 2 and the distance 40A, 42A shown in FIG. 6 is equal to the distance that the vane assemblies 30 moved away from each other.

The initial spacing of the second projection surfaces 40A2, 42A2 and the second inner surfaces 32A2, 32B2 in the neutral position allows the first and second vane assemblies 30 to move circumferentially toward each other. The initial spacing between the first projection surfaces 40A1, 42A1 and the first inner surfaces 32A1, 32B1 in the neutral position allows the first and second vane assemblies 30 to move circumferentially away from each other. Moreover, when the first and second vane assemblies 30 to move circumferentially away from each other, the first projection surface 40A1, 40A2 will eventually engage the first inner surface 32A1, 32B1 so as to delimit movement of the first and second vane assemblies 30 circumferentially away from each other. As noted above, the movement of the vane assemblies 30 relative to each other may be caused by thermal expansion or thermal contraction of the vane assemblies 30 and their components, and/or caused by thermal expansion and/or thermal contraction of components contacting the vane assemblies 30 or otherwise affecting the positioning of the vane assemblies 30 and their components.

As described above, the vane assemblies 30 are formed via additive layer manufacturing which, among other advantages, provides for high sealing performance due to the high accuracy of machining that additive layer manufacturing is capable of. Moreover, the first seal 38 shown in FIGS. 2 and 4-7, as well as the other seals described herein, can be formed in a great variety of configurations and shapes, in particular due to the seal not having to be manually inserted into the grooves but instead formed integrally with the vane assemblies 30.

Moreover, because the seals described herein are essentially locked into place via the projecting portions, the likelihood of the seal escaping the grooves during operation of the engine 10 is significantly reduced. To this point, the seals can be arranged in the grooves without openings on any side of the grooves (see, e.g., FIG. 4, which shows how the seal 38 is contained within the grooves 31A, 31B without openings on any side of the grooves 31A, 31B, such as openings in the radial, axial, and circumferential sides of the grooves 31A, 31B). Accordingly, there are no openings, other than the gaps 34, 35, through which the seals may escape during operation of the engine 10. The enclosed nature of the grooves also eases assembly of the vane assemblies since, as noted above, the seals do not have to be manually inserted into the grooves during assembly.

The additive manufacturing methods described herein, in particular forming the described vane assemblies and engine components including the seal or seals therebetween, can further result in less tolerance stack, which can result in a more streamlined design process. Furthermore, forming the vane assemblies and/or engine components in a single fabrication operation can reduce overall machining time, as well as potentially reducing the number of tools required for manufacturing, inspection, and assembly.

A method according a further aspect of the present disclosure includes additively manufacturing a first engine component of a gas turbine engine, a second engine component of the gas turbine engine arranged adjacent to the first engine component, (the first and second engine components, in some embodiments, being the vane assemblies 30 described above, although also potentially encompassing the other components of the engine noted above, or any other engine component in which the seals described herein can be utilized) and first seal, such as the first seal 38 described above or any seal described herein, arranged between the first and second engine components. The first and second engine components and the first seal are formed in a single fabrication operation, as described above.

The additive layer manufacturing process can include, for example, steps of forming the assemblies described herein, layer-by-layer, via a repetitive process of adding layers of a base material, manipulating the base material via an energy source, and solidifying the layer before moving to the next layer. The additive layer manufacturing process may include similar processes, including additional or alternative steps to these basic steps, known to those skilled in the art, so long as the assemblies are formed in a single fabrication process or operation in a layer-by-layer fashion.

FIG. 7 shows a non-limiting example of an additive manufacturing process in a radial direction of the vane assemblies 30 and seal 38, which can include adding a first layer 106 of additive powder material to a build platform 101 of an additive layer manufacturing machine 100, projecting an energy source 102 at the first layer 106 so as to selectively form a desired geometry on the first layer 106, and solidifying the first layer 106 having the desired geometry. The method can further include repeatedly stacking successive layers 108 on top of one another, in particular via lowering the build platform 101, adding additional additive powder material to a previous layer 108, projecting the energy source 102 on the successive layer 108, and solidifying the successive layer 108 to additively manufacture the vane assemblies described herein (also referred to as “engine components”), such as the vane assemblies 30 and first seal 38 described above. It is noted that the layers 106, 108 shown in FIG. 7 are shown much larger than actual size in order to illustrate the concepts described herein. Although this exemplary fabrication process shows specific sizes and orientations of layers, other configurations of layers, as well as formation in other directions of the vane ring 24 such as axially, circumferentially, or any combination of directions, are contemplated by the present disclosure.

In some embodiments, as shown in FIG. 7 sacrificial standoffs 50, 51, 52, 53 may be formed via the additive layer manufacturing during construction of the vane assemblies 30 in order to support the seal 38 within the grooves 31A, 31B, the sacrificial standoffs 50, 51, 52, 53 being configured to break off or be etched away after the vane assemblies 30 have cooled and solidified. In some embodiments, the removal can include applying a chemical agent to the assembly in order to etch away the standoffs (i.e. via chemical etching), or the standoffs can be physically removed via machining or similar methods. In some embodiments, the method can further include determining circumferential distances that the first and second vane assemblies 30 (or “engine components”) can move relative to each other due to thermal expansion and/or thermal contraction when arranged in the gas turbine engine 10 and subject to thermal stresses. The method can further include additively manufacturing the projection receiving recesses 32A, 32B such that a distance between the inner surfaces 32A1, 32B1, 32A2, 32B2 of the projection-receiving recesses 32A, 32B and the projecting portions 40, 42 allows the first and second vane assemblies 30 (or “engine components) to move the determined circumferential distances during thermal expansion and/or thermal contraction of the first and second vane assemblies 30 (or “engine components).

Alternative embodiments of the seal and vane assemblies are described below, each of which may be formed via the additive layer manufacturing methods described herein. It is noted that, although not specifically described in as great of detail as the embodiment shown in FIGS. 2 and 4-7, the principal of operation remains the same for each of the alternative embodiments described below, namely that the seals each include projecting portions at one or both ends that are spaced apart from corresponding projection-receiving recesses so as to allow for both movement of the vane assemblies toward each other and to delimit movement of the vane assemblies away from each other during thermal expansion and/or thermal contraction of the vane assemblies and/or neighboring components. Moreover, although not shown in detail, the gas flow path 60 travels around the seals in a similar manner as the embodiment shown in FIGS. 2 and 4-7, and can be similarly affected by movement of the seals with the grooves.

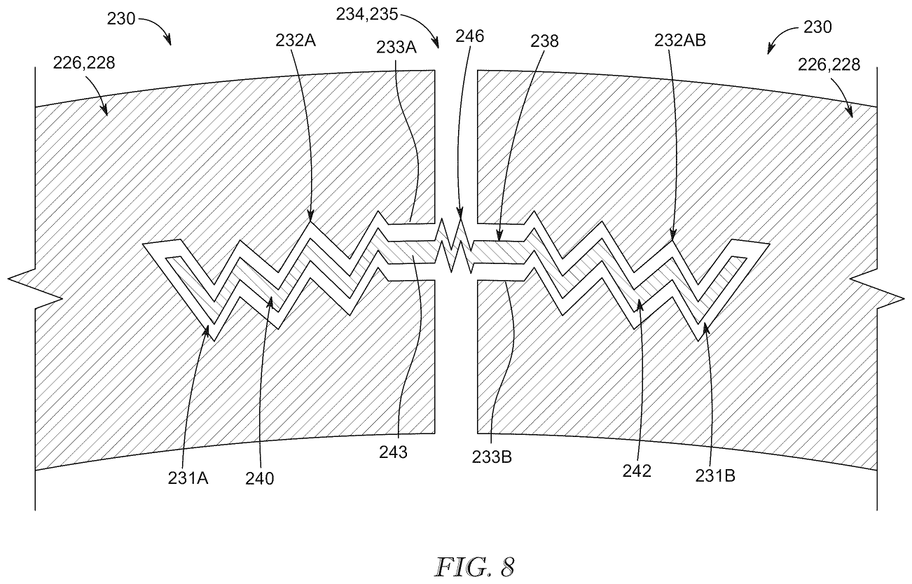

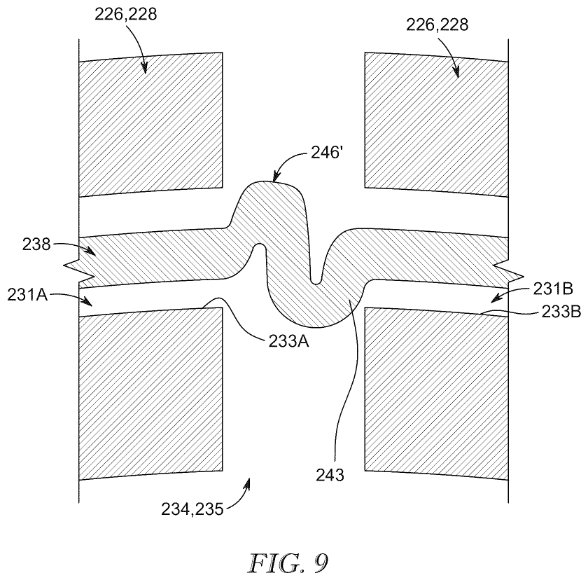

Another embodiment of vane assemblies 230 and seals 238 that are configured to be utilized in the vane ring 24 of the gas turbine engine 10 is shown in FIGS. 8 and 9. The vane assemblies 230 are similar to the vane assemblies 30 described herein. Accordingly, similar reference numbers in the 200 series indicate features that are common between the vane assemblies 230 and the vane assemblies 30. The description of the vane assemblies 30 is incorporated by reference to apply to the vane assemblies 230, except in instances when it conflicts with the specific description and the drawings of the vane assemblies 230.

The vane assemblies 230 are formed substantially similarly to the vane assemblies 30 described herein. Unlike the seal 38 and the grooves 31A, 31B of the vane assemblies 30, the seal 238 and the grooves 231A, 231B are formed to have an alternating radially-outwardly extending and radially-inwardly extending shape known colloquially as a zig-zag pattern, with the portions of the zig-zag pattern that extend at least partially radially providing the surfaces that allow for circumferential movement and delimit circumferential movement of the vane assemblies 230.

Specifically, as can be seen in FIG. 8, the grooves 231A, 231B include a main groove portion 233A, 233B and projection-receiving recesses 232A, 232B formed in the zig-zag pattern. The projecting portions 240, 242 are formed to have corresponding zig-zag patterns as the projection-receiving recesses 232A, 232B, and are arranged within the projection-receiving recesses 232A, 232B to be spaced apart from inner surfaces of the projection-receiving recesses 232A, 232B so as to allow for the thermal expansion, thermal contraction, and resulting movement of the vane assemblies 230 relative to each other.

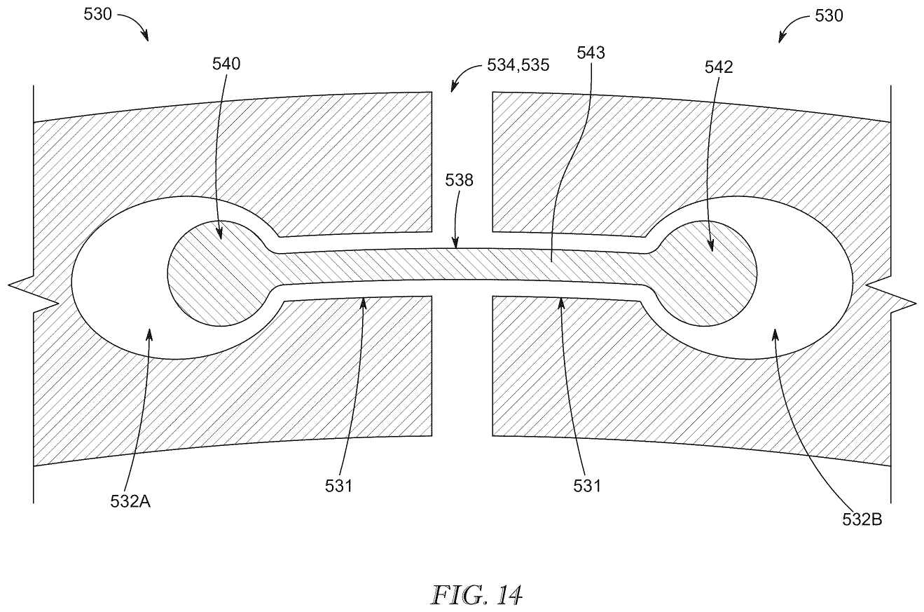

Illustratively, the main body 243 of the seal 238 can include a spring 246 formed thereon, and in some embodiments, formed as an integrally with the main body 243 (i.e. the central area of the main body 243 is a spring 246), as shown in FIG. 8. The spring 246 can serve to dampen the movement of the vane assemblies 230 away from and toward each other, and in some embodiments, is capable of aiding in maintaining thermal compliance when the gap 234, 235 progressively closes. Regarding thermal compliance, if the rate of expansion or contraction of the vane assemblies 230 would create loading in the seal 238, the spring 246 could be utilized to relieve loading of the seal 238 itself. This could occur if the grooves 231A, 231B are not oversized enough as compared to the projecting portions 240, 242. As with the other embodiments described herein, the seal 238 should be long enough to maintain an adequate seal while also being short enough to avoid thermally-induced binding, or have a seal to create thermal compliance. For example, as can be seen in FIG. 14, any issues with binding or compressing of the seal 538 are less likely to occur due to how oversized the projection-receiving recesses 532A, 532B are relative to the projecting portions 540, 542 (i.e. allowing for more movement of the vane assemblies 530 relative to each other). Because the grooves 231A, 231B more closely adhere to the shape of the projecting portions 240, 242 and thus might be more susceptible to binding or compressing, the spring 246 can aid in avoiding this binding or compression. In other words, the seal 238 is thermally complaint by virtue of, at least in part, the spring 246, as opposed to the projection-receiving recesses being made larger (FIG. 14).

In some embodiments, the spring 246 may include a zig-zag shape similar to the first and second projecting portions 240, 242, as shown in FIG. 8. In other embodiments, as shown in FIG. 9, an alternative spring 246′ can include a wave pattern in which the spring 246′, from left to right as viewed in FIG. 9, extends along the generally circumferentially extending main body 243, then curves radially outwardly, then radially inwardly, then radially outwardly before returning to the generally circumferentially extending main body 243.

Another embodiment of vane assemblies 330 and seals 338 that are configured to be utilized in the vane ring 24 of the gas turbine engine 10 is shown in FIGS. 10-12. The vane assemblies 330 are similar to the vane assemblies 30, 230 described herein. Accordingly, similar reference numbers in the 300 series indicate features that are common between the vane assemblies 330 and the vane assemblies 30, 230. The descriptions of the vane assemblies 30, 230 are incorporated by reference to apply to the vane assemblies 330, except in instances when they conflict with the specific description and the drawings of the vane assemblies 330.

The vane assemblies 330 are formed substantially similarly to the vane assemblies 30, 230 described herein. Unlike the seals 38, 238 and the grooves 31A, 31B, 231A, 231B of the vane assemblies 30, 230, the seal 338 and the grooves 331A, 331B are formed as labyrinth seals that include multiple projecting portions 340, 342 at opposing ends of the main body 343, the main body 343 extending along a majority of the circumferential length of the grooves 331A, 331B. As can be seen in FIG. 10, the projecting portions 340, 342 extend radially inwardly and may be formed as triangular shapes having a pointed tip. The tips of the projecting portions 340, 342 may each create a knife edge similar to a labyrinth seal utilized between static and rotating gas turbine components.

Each of the projecting portions 340, 342 is arranged in corresponding protrusion receiving recesses 332A, 332B formed in the grooves 331A, 331B. The protrusion-receiving recesses 332A, 332B can be formed between radially extending ridges 332A1, 332B1 extending from a lower inner surfaces 331A1, 331B1 of the grooves 331A, 331B. In some embodiments, each end of the main body 343 includes three projecting portions 340, 342, although more or fewer may be included depending on the design requirements of the vane ring 24. The main body 343 may also include a spring 346 arranged centrally between the innermost projecting portions 340, 342.

As shown in FIG. 10, the multiple projecting portions 340, 342 create a tortuous path 360 for the gas to flow around the seal 338. In some scenarios during usage of the seal 338 and vane assemblies 330 in the gas turbine engine 10, differential pressure on opposing radial sides of the seal 338 can cause the seal 338 to move radially, such as, for example, radially inwardly in the direction 90 shown in FIG. 11. When the seal 338 is moved radially inwardly, the tips of the projecting portions 340, 342 contact the radially outwardly-facing inner surfaces of the grooves 331A, 331B, as shown in FIG. 11. In this way, the seal 338 can more effectively block the gases from flowing along the flow path 360 and out of the main gas flow path of the engine 10. It is noted that the seal 338 and corresponding grooves 331A, 331B can be flipped 180 degrees to account for the differential pressure moving the seal 338 radially outwardly, such as when the seal 338 is arranged between the inner vane platforms 328.

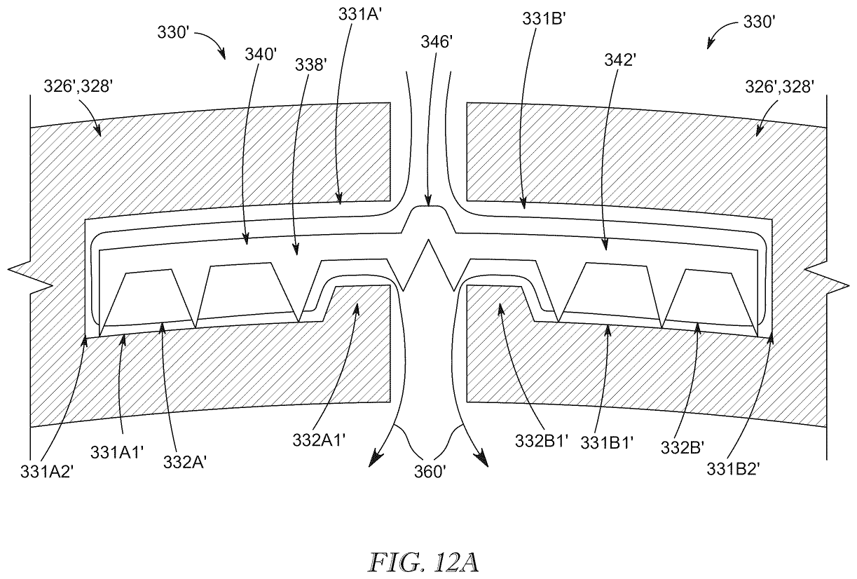

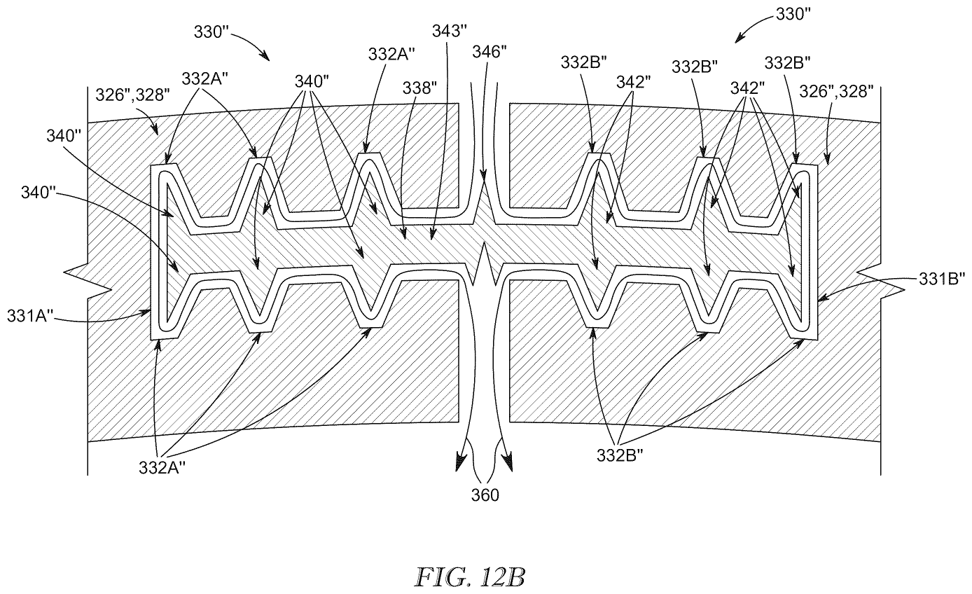

In some embodiments, the grooves 331A, 331B do not include multiple ridges 332A1, 332B1 to define multiple recesses 332A, 332B therebetween. Instead, alternative grooves 331A′, 331B′ are show in FIG. 12A, which each only include a single ridge 332A1′, 332B1′ defining a projection-receiving recess 332A′, 332B′ between the ridge 332A1′, 332B1′ and the far end 331A2′, 331B2′ of the groove 331A′, 331B′. All of the projecting portions 340′, 342′ may fit within the single projection-receiving recess 332A′, 332B′ of each groove 331A′, 331B′. As can be seen in FIG. 12A, which shows the seal 338′ being pressed against the lower inner surfaces 331A1′, 331B1′ of the grooves 331A′, 331B′, the points of the projecting portions 340′, 342′ contact the lower inner surfaces 331A1′, 331B1′ and thus can effectively serve the same purpose as the projecting portions 340, 342 shown in FIGS. 10 and 11, namely more effectively blocking the gases from flowing along the flow path 360′.

In some embodiments, the projection portions 340″, 342″ may be formed on opposing radially outwardly and inwardly sides of the main body 343″, and the same protrusion-receiving recesses 332A″, 332B″ as those described above with regard to FIG. 10 (protrusion-receiving recesses 332A, 332B) can be formed in both the radially outward and radially inward surfaces of the grooves 331A″, 331B″, as shown in FIG. 12B.

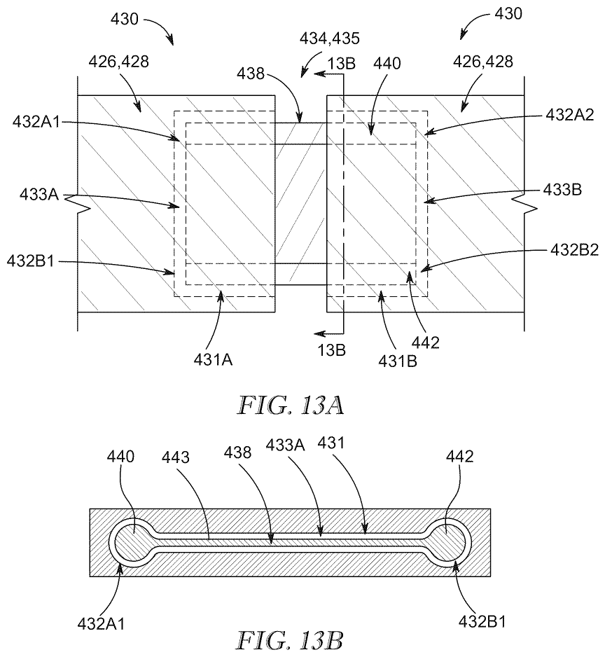

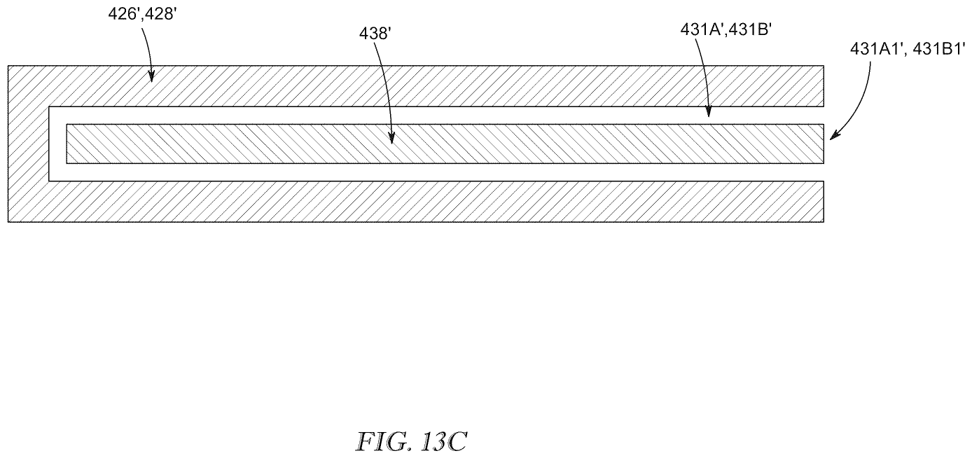

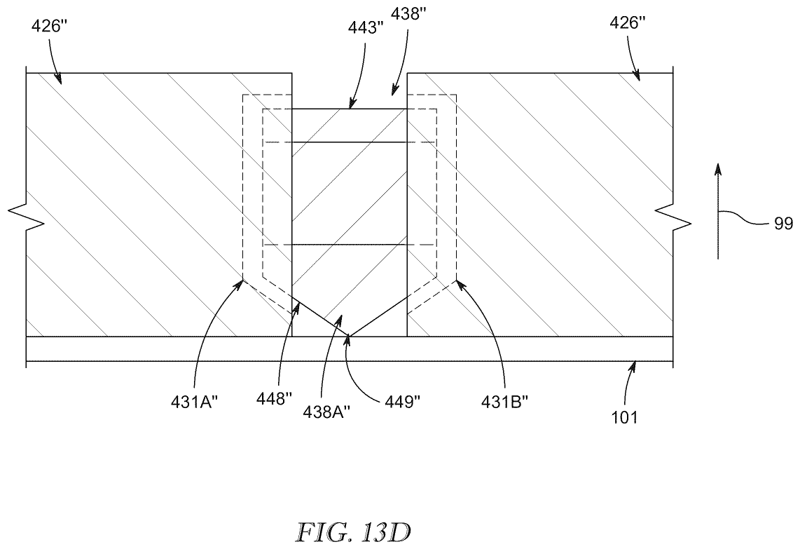

Another embodiment of vane assemblies 430 and seals 438 that are configured to be utilized in the vane ring 24 of the gas turbine engine 10 is shown in FIGS. 13A-13C. The vane assemblies 430 are similar to the vane assemblies 30, 230, 330 described herein. Accordingly, similar reference numbers in the 400 series indicate features that are common between the vane assemblies 430 and the vane assemblies 30, 230, 330. The descriptions of the vane assemblies 30, 230, 330 are incorporated by reference to apply to the vane assemblies 430, except in instances when they conflict with the specific description and the drawings of the vane assemblies 430.

The vane assemblies 430 are formed substantially similarly to the vane assemblies 30, 230, 330 described herein. Unlike the seals 38, 238, 338 and the grooves 31A, 31B, 231A, 231B, 331A, 331B of the vane assemblies 30, 230, 330, the seal 438 and the grooves 431A, 431B are formed to extend axially as opposed to circumferentially, as shown in FIGS. 13A and 13B. In particular, the grooves 431A, 431B are formed to include the same main groove portion 433A, 433B and projection-receiving recesses 432A1, 432B1, 432A2, 432B2, but instead of one projection-receiving recess being arranged in one of the vane assemblies 430 and the other projection-receiving recess being arranged in the other vane assembly 430, each vane assembly 430 includes two projection-receiving recesses 432A1, 432B1, 432A2, 432B2, with opposing first projection-receiving recesses 432A1, 432A2 (opposed in the circumferential direction) and opposing second projection-receiving recesses 432B1, 432B2 being aligned with each other so as to receive the projecting portions 440, 442 of the seal 438.

The projecting portions 440, 442 extend circumferentially as opposed to axially as shown, for example, in the embodiment of FIGS. 2 and 4-7. As can be seen more clearly in FIG. 13B, the projecting portions 440, 442 can include similar annular portions as the projecting portions 40, 42 that are larger than the main body 443 of the seal 438. The seal 438 being formed in this manner provides additional security of the seal 438 within the grooves 431A, 431B, in particular with regard to movement in the axial direction.

It is contemplated that the axially-extending projecting portions 40, 42 and the circumferentially-extending projecting portions 440, 442 can be used in combination with each other in some embodiments so as to even further secure the seal within the grooves. This holds true for other embodiments disclosed herein as well, as any combination of different seal parts and features is contemplated by the present disclosure. In this way, the vane assemblies can be constructed with specific, unique projecting portions based on specific planned designs and usage scenarios of the engine 10. For example, in some embodiments, each seal can include multiple types of projecting portions. In some embodiments, different types of projecting portions may be utilized about the circumference of the vane ring. In some embodiments, different types of projecting portions may be utilized in different vane rings along the axial and radial extents of the turbine or other engine sections.

In other embodiments, the seal 438′ may not include projecting portions, but instead be formed as a strip seal 438′ that is generally flat and planar, as shown in FIG. 13C. In such an embodiment, an axial end 431A1′, 431B1′ of the grooves 431A′, 431B′ can be open so as to allow for selective removal and replacement of the seal 438′. The open ends 431A1′, 431B1′ can also allow for replacement of the vane assemblies 430′ themselves if necessary.

In some embodiments, a side of the seal 438″ which faces the opposite of a build direction 99 of the manufacturing process may include a type of extension or protrusion that provides support of the relatively unsupported side of the seal 438″ during manufacturing. For example, as shown in FIG. 13D, the forward side 448″, also referred to as an axially forward side surface 448″, of the seal 438″ may be formed to have a protruding support 438A″ that extends to the build platform 101 to provide support for the central portion or main body 443″ of the seal 438″. In some examples, the protruding support 438A″ may be a triangular shape with a lower tip 449″ when viewed in the radial direction as shown in FIG. 13D, such that the lower tip 449″ of the triangle faces opposite the build direction 99, which is typically vertical.

The lower tip 449″ may be formed on the build platform 101 so as to support the remainder of the seal 438″ as it is being built up. Although a triangle is shown, any other shape capable of supporting the seal 438″ as it is being built up may be utilized. In some embodiments, the protruding support 438A″ may be removed, via machining, chemical etching, or other means, during post-processing. Utilizing the protruding support 438A″ may be particularly advantageous due to the side surface 448″ (or the side 48 in the previous embodiments) being relatively unsupported during some additive manufacturing processes and being subjected to gravity and other forces. Moreover, the side surface 448″ being angled relative to the vane assemblies 426″ may provide additional support as well during the manufacturing process.

Another embodiment of vane assemblies 530 and seals 538 that are configured to be utilized in the vane ring 24 of the gas turbine engine 10 is shown in FIG. 14. The vane assemblies 530 are similar to the vane assemblies 30, 230, 330, 430 described herein. Accordingly, similar reference numbers in the 500 series indicate features that are common between the vane assemblies 530 and the vane assemblies 30, 230, 330, 430. The descriptions of the vane assemblies 30, 230, 330, 430 are incorporated by reference to apply to the vane assemblies 530, except in instances when they conflict with the specific description and the drawings of the vane assemblies 530.

The vane assemblies 530 are formed substantially similarly to the vane assemblies 30, 230, 330, 430 described herein, and in particular very similarly to the vane assemblies 30 described with regard to FIGS. 2 and 4-7. The vane assemblies 530 illustrate an exemplary manner in which the projection-receiving recesses 532A, 532B can be specifically tailored to account for a predetermined amount of thermal expansion, thermal contraction, or any other movement of the vane assemblies 530 relative to each other. In the example shown in FIG. 14, a circumferential movement distance may be determined before construction of the vane assemblies 530, which in the present example may be greater than a possible circumferential movement distance of the vane assemblies 30 shown in FIGS. 2 and 4-7. As such, the projection-receiving recesses 532A, 532B can be formed to be larger than the projection-receiving recesses 32A, 32B described above to allow for this additional movement.

In the example shown in FIG. 14, the gap 534, 535 may be larger than the gap 34, 35 described above, and as such, additional space is needed between the outer side of the projecting portions 540, 542 and the corresponding inner surface of the projection-receiving recesses 532A, 532B. FIG. 14 shows only one example of how the components of the vane assemblies 530 may be adjusted to account for projected movement of the vane assemblies 530 relative to each other. Indeed, any other modifications to the projection-receiving recesses 532A, 532B, as well as to other components such as the seals 538 themselves, that would account for more or less projected movement of the vane assemblies 530 relative to each other are contemplated by the present disclosure.

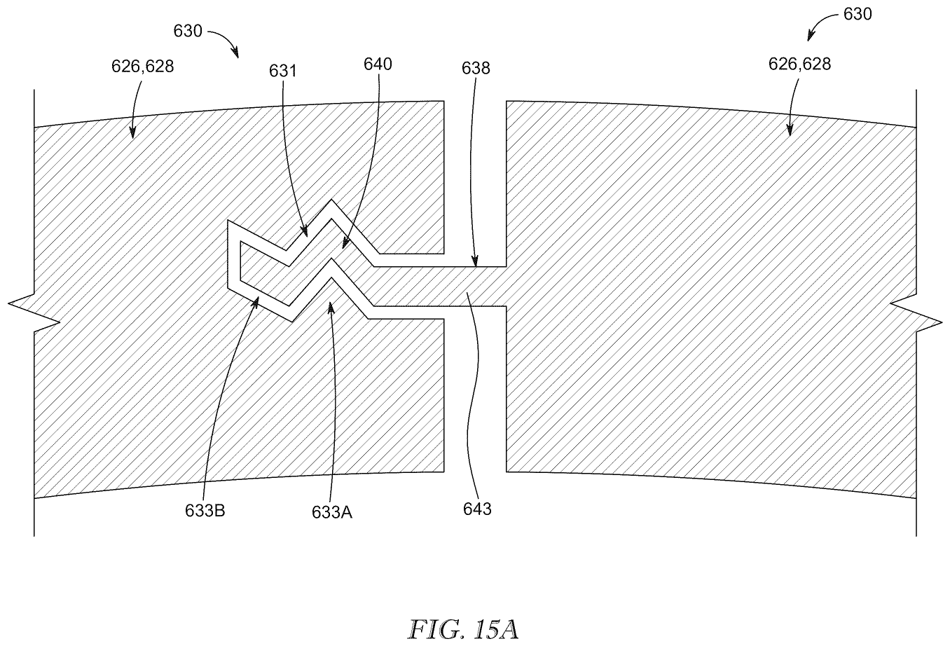

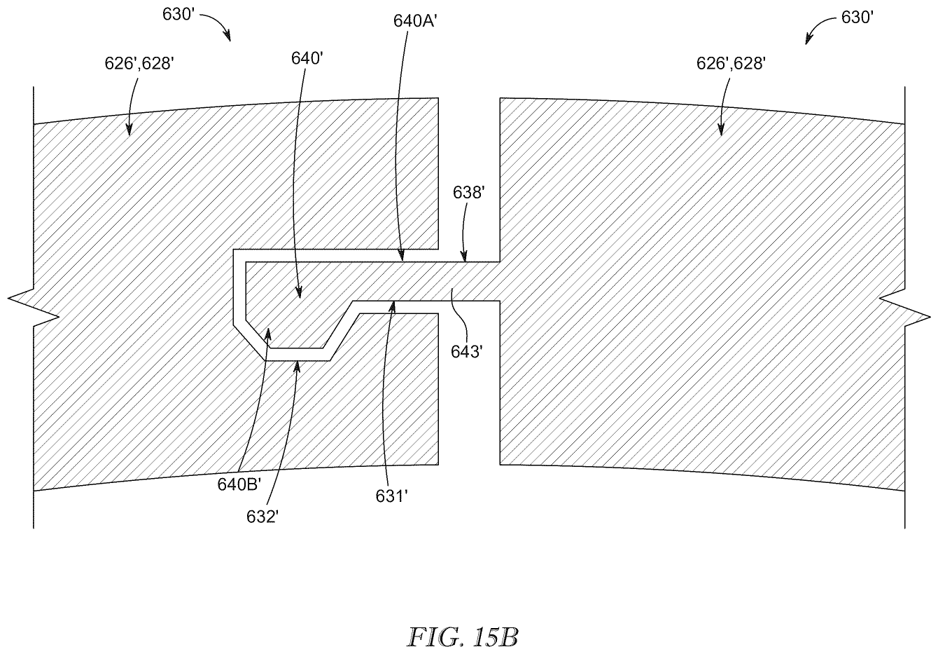

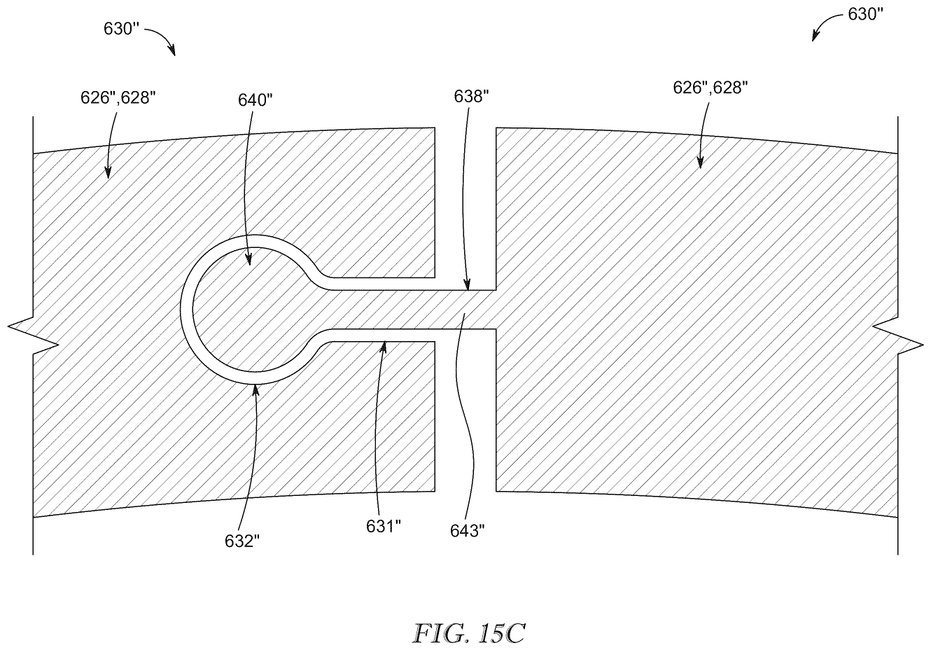

Another embodiment of vane assemblies 630 and seals 638 that are configured to be utilized in the vane ring 24 of the gas turbine engine 10 is shown in FIGS. 15A-15C. The vane assemblies 630 are similar to the vane assemblies 30, 230, 330, 430, 530 described herein. Accordingly, similar reference numbers in the 600 series indicate features that are common between the vane assemblies 630 and the vane assemblies 30, 230, 330, 430, 530. The descriptions of the vane assemblies 30, 230, 330, 430, 530 are incorporated by reference to apply to the vane assemblies 630, except in instances when they conflict with the specific description and the drawings of the vane assemblies 630.

The vane assemblies 630 are formed similarly to the vane assemblies 30, 230, 330, 430, 530 described herein, but instead of adjacent vane assemblies each including a groove that opens toward the opposing vane assembly, only one of the adjacent vane assemblies 630 includes a groove 631, while the other vane assembly 630 does not. As can be seen in FIG. 15A, the seal 638 includes a projecting portion 640 on a first end of the seal 638, and a second end of the seal 638 opposite the first end is coupled directly to the vane platform 626, 628 of the other vane assembly 630. The coupling of the seal 638 to the vane assembly 630 provides an anchor point for the seal 638, thus further securing the seal 638 within the groove 631 and between the vane assemblies 630.

In some embodiments, as shown in FIG. 15A the projecting portion 640 of the seal 638 and the corresponding projection-receiving recess 632 can include the zig-zag type shape shown in FIG. 8. In some embodiments, as shown in FIG. 15B, the projecting portion 640′ of the seal 638′ can include a flat upper surface 640A′ and a downwardly extending ridge 640B′ having a flat radially inwardly-facing surface. The projection-receiving recess 632′ is formed to match the shape of the downwardly extending ridge 640B′. In some examples, the radially inwardly-facing surface may not be flat but instead be formed as a single point similar to the embodiments shown in FIGS. 10-12B. In some embodiments, as shown in FIG. 15C the projecting portion 640″ of the seal 638″ and the corresponding projection-receiving recess 632″ can include the annular shape shown in FIGS. 2 and 4-7.

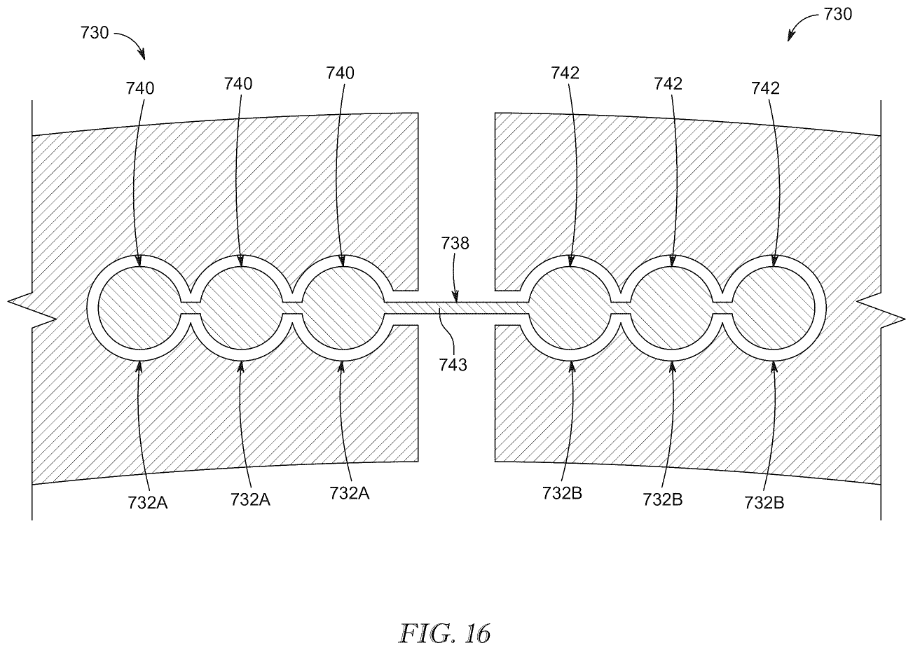

Another embodiment of vane assemblies 730 and seal 738 that are configured to be utilized in the vane ring 24 of the gas turbine engine 10 is shown in FIG. 16. The vane assemblies 730 are similar to the vane assemblies 30, 230, 330, 430, 530, 630 described herein. Accordingly, similar reference numbers in the 700 series indicate features that are common between the vane assemblies 730 and the vane assemblies 30, 230, 330, 430, 530, 630. The descriptions of the vane assemblies 30, 230, 330, 430, 530, 630 are incorporated by reference to apply to the vane assemblies 730, except in instances when they conflict with the specific description and the drawings of the vane assemblies 730.

The vane assemblies 730 are formed similarly to the vane assemblies 30, 230, 330, 430, 530, 630 described herein, and in particular, very similar to the vane assemblies 30 shown in FIGS. 2 and 4-7. Instead of having a single annular projecting portion 40, 42 on each end of the seal 38, the seal 738 includes multiple annular projecting portions 740, 742 on each end of the seal 738. The projecting portions 740, 742 may be formed adjacent to each other and be received in corresponding projection-receiving recesses 732A, 732B. In some embodiments, the seal 738 includes three projecting portions 740, 742 on each end of the seal 738 which are each received in a respective projection-receiving recess 732A, 732B.

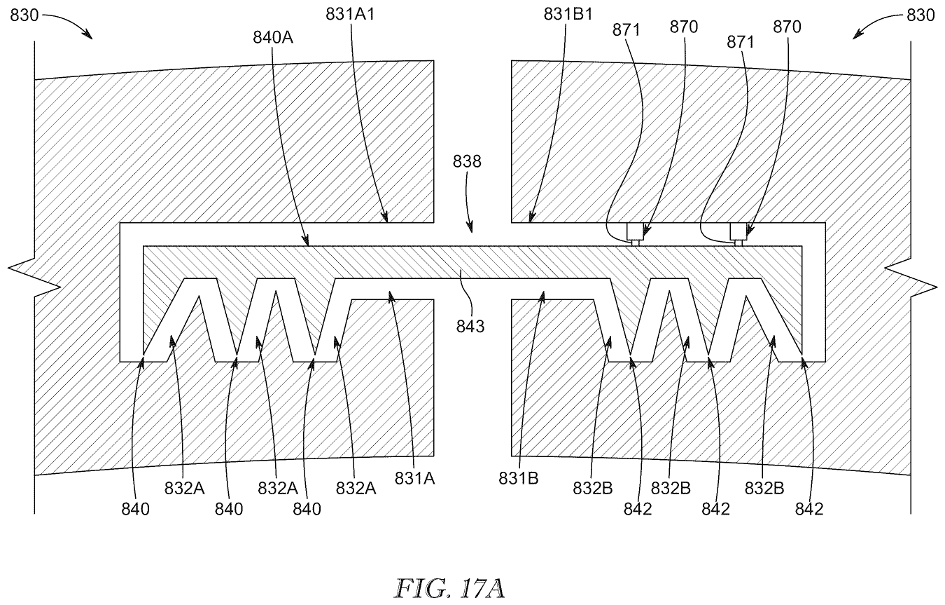

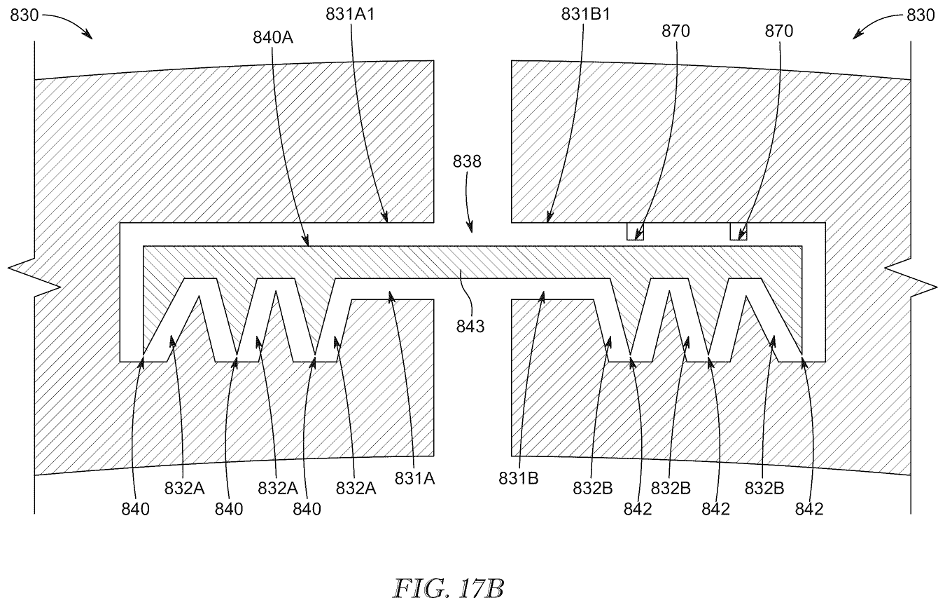

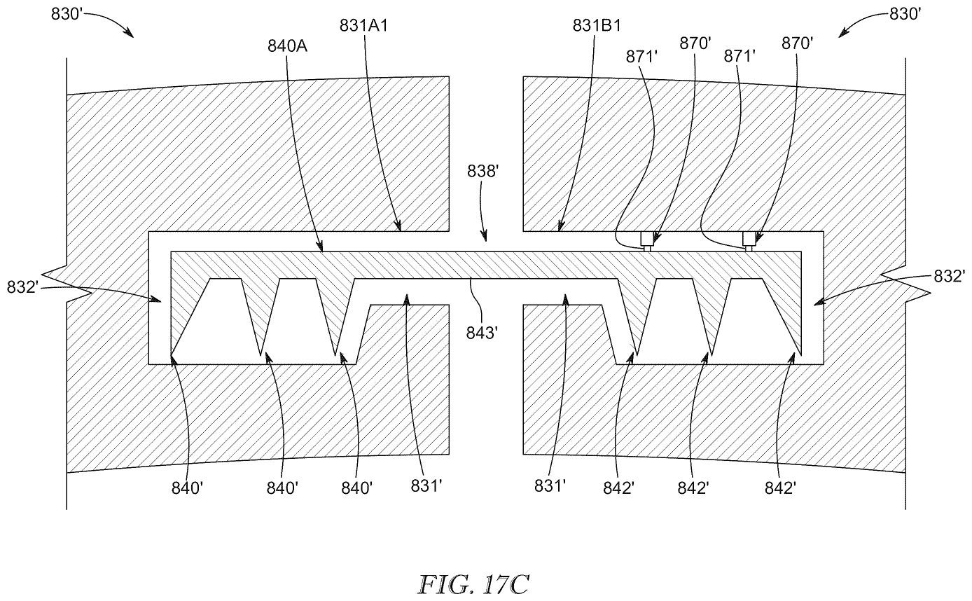

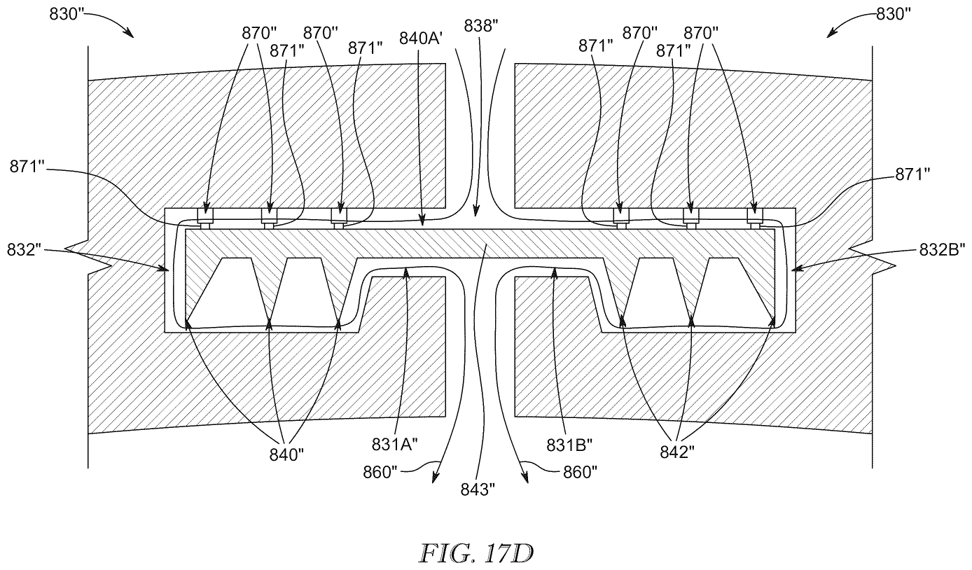

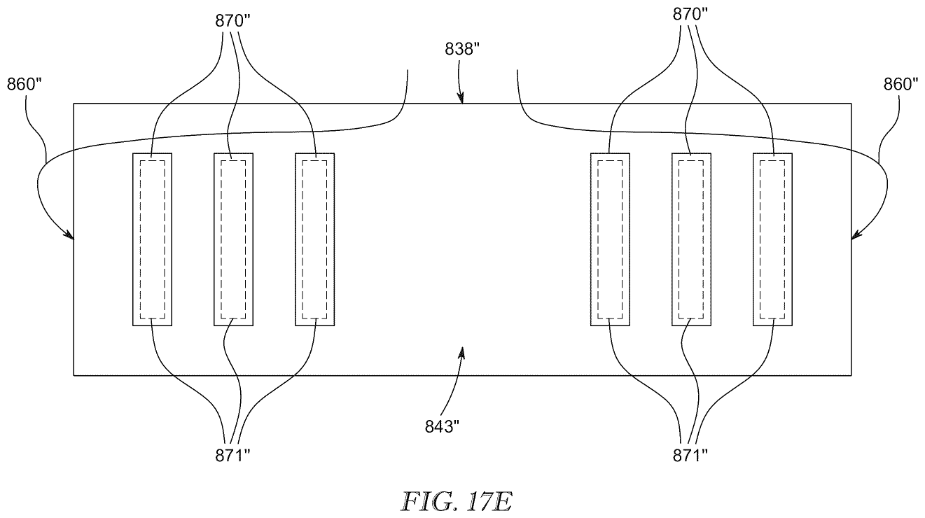

Another embodiment of vane assemblies 830 and seals 838 that are configured to be utilized in the vane ring 24 of the gas turbine engine 10 is shown in FIGS. 17A-17D. The vane assemblies 830 are similar to the vane assemblies 30, 230, 330, 430, 530, 630, 730 described herein. Accordingly, similar reference numbers in the 800 series indicate features that are common between the vane assemblies 830 and the vane assemblies 30, 230, 330, 430, 530, 630, 730. The descriptions of the vane assemblies 30, 230, 330, 430, 530, 630, 730 are incorporated by reference to apply to the vane assemblies 830, except in instances when they conflict with the specific description and the drawings of the vane assemblies 830.

The vane assemblies 830 are formed similarly to the vane assemblies 30, 230, 330, 430, 530, 630, 730 described herein, and in particular, very similar to the vane assemblies 330 shown in FIGS. 10-12. Specifically, the seal 838 shown in FIG. 17A is essentially the same as the seal 338 shown in FIG. 10, in particular to include projection-receiving recesses 832A, 832B in the grooves 831A, 831B and the projections 840, 842 arranged therein. The seal 838 and grooves 831A, 831B also include small obstructing members 870 arranged in one of the grooves 831A, 831B that extend between a radially inwardly-facing surface 831A1, 831B1 of the groove 831A, 831B and a radially outwardly-facing surface 840A of the first seal 838 so as to create a tortuous path around the seal 838 for the gases to flow over.

As can be seen in FIG. 17A, each obstructing member 870 can be formed to include a sacrificial nub 871 at one end of the obstructing member 870. The nub 871 can be formed on either end of the obstructing member 870. The nub 871 can include a width (or diameter if the obstructing member 870 is formed to be cylindrical) that is less than that of the obstructing member 870. The nub 871 interconnects the obstructing member with the radially inwardly-facing surface 831A1, 831B1 of the groove 831A, 831B and the radially outwardly-facing surface 840A of the first seal 838, which is particularly useful during formation of the vane assemblies 830 and seal 838 during additive layer manufacturing. The nub 871 can be removed in post-processing such that the seal 838 can become separate from the vane assemblies 830, and the obstructing members 870 can remain so as to create the tortuous path around the seal 838. The nubs 871 can be removed via any of the methods described above.

The seal 838′ shown in FIG. 17B is essentially the same as the seal 338′ shown in FIG. 12A, but also includes the small obstructing members 870′ arranged in one of the grooves 831A′, 831B′ that extend between the radially inwardly-facing surface 831A1′, 831B1′ of the groove 831A′, 831B′ and the radially outwardly-facing surface 840A′ of the first seal 838′. FIG. 17C shows a seal 838″ formed the same as the seal 838′ shown in FIG. 17B, but with obstructing members 870″ arranged in both grooves 831A″, 831B″ as opposed to only one of the grooves 831A″, 831B″. FIG. 17D shows a radially inwardly-facing view of the seal 838″ showing how the obstructing members 870″ can extend only partially axially along an axial extent of the seal 838″ so as to allow the gas path 860″ to extend around them.

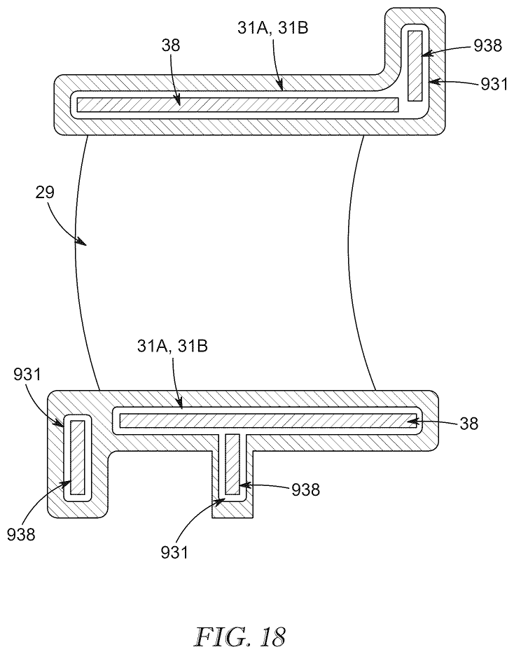

FIG. 18 shows that the seals can be arranged in other types of grooves formed on circumferentially-facing sides of the vane assembly. For example, as shown in FIG. 18, seals 38, which can be any of the seals described herein, may be arranged in axially and circumferentially extending grooves 31A, 31B, as noted in the embodiments described above. In addition to or alternatively to these seals 38, additional seals 938, which can be any of the seals described herein, may be arranged in radially and circumferentially extending grooves 931 similar to how the seals are arranged in the other embodiments described herein.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A gas turbine engine comprising:
a first vane assembly including a first vane platform extending circumferentially about a central axis of the gas turbine engine and a first vane extending radially away from the first vane platform and configured to interact with gases flowing through the gas turbine engine, the first vane platform including a first groove formed in a first circumferentially-facing side wall of the first vane platform that opens in a first circumferential direction,
a second vane assembly arranged circumferentially adjacent to the first vane assembly and including a second vane platform extending circumferentially about the central axis and a second vane extending radially away from the second vane platform and configured to interact with the gases flowing through the gas turbine engine, the second vane platform including a second groove formed in a second circumferentially-facing side wall of the second vane platform that opens in a second circumferential direction opposite the first circumferential direction, and
a first seal arranged between the first and second vane platforms that extends circumferentially, the first seal having a first end arranged in the first groove and a second end arranged in the second groove, the first seal configured to block the gases flowing over the first and second vanes from passing through a circumferential gap between the first and second vane platforms,
wherein the first seal includes a main body extending between the first and second vane platforms, a first projecting portion at the first end of the first seal arranged within a corresponding first projection receiving recess formed in the first groove, and a second projecting portion at the second end of the first seal arranged within a corresponding second projection receiving recess formed in the second groove so as to allow for thermal expansion of the first and second vane assemblies while delimiting movement of the first and second vane assemblies circumferentially away from each other, the first and second projecting portions each defining a first radial thickness that is greater than a second radial thickness of the main body, and wherein the first vane assembly, the second vane assembly, and the first seal are formed in a single fabrication operation.

2. The gas turbine engine of claim 1, wherein the first vane assembly, the second vane assembly, and the first seal are formed integrally as a single, monolithic component via additive layer manufacturing.

3. The gas turbine engine of claim 1, wherein the first projecting portion is spaced apart from an inner surface of the first projection receiving recess in a neutral position of the first seal so as to allow the first and second vane assemblies to move circumferentially toward each other, and wherein, in response to the first and second vane assemblies moving circumferentially away from each other, the first projecting portion engages the inner surface so as to delimit movement of the first and second vane assemblies circumferentially away from each other.

4. The gas turbine engine of claim 3, wherein the first projecting portion includes a first projection surface that faces at least partially in the first circumferential direction and a second projection surface that faces at least partially in the second circumferential direction, and wherein the inner surface of the first projection receiving recess includes a first inner surface adjacent to and spaced apart from the first projection surface and a second inner surface adjacent to and spaced apart from the second projection surface in the neutral position of the first seal.

5. The gas turbine engine of claim 4, wherein, in response to movement of the first and second vane assemblies circumferentially away from each other, the first projection surface engages the first inner surface so as to delimit movement of the first and second vane assemblies circumferentially away from each other, and wherein, in response to movement of the first and second vane assemblies circumferentially toward each other during thermal expansion of the first and second vane assemblies, the second projection surface moves toward the second inner surface and the first projection surface moves away from the first inner surface so as to allow for movement of the first and second vane assemblies circumferentially toward each other.

6. (canceled)

7. (canceled)

8. The gas turbine engine of claim 1, wherein the first and second projecting portions each include a rounded portion when viewed along the central axis, wherein the first and second projection receiving recesses each include a rounded portion when viewed along the central axis corresponding to the rounded portions of the first and second projecting portions arranged therein, wherein an outer surface of each rounded portion of the first and second projecting portions is spaced apart from an inner surface of the rounded portion of the respective projection receiving recess in a neutral position of the first seal so as to allow the first and second vane assemblies to move circumferentially toward each other, and wherein, in response to the first and second vane assemblies moving circumferentially away from each other, the outer surface of each rounded portion of the first and second projecting portions engages the inner surface of the rounded portion of the respective projection receiving recess so as to delimit movement of the first and second vane assemblies circumferentially away from each other.

9. The gas turbine engine of claim 1, wherein the first and second projecting portions each include at least one first radially projecting portion extending radially inwardly, wherein the first and second projection receiving recesses each include at least one second radially projecting portion circumferentially offset from the at least one first radially projecting portion in a circumferential direction toward the opposing vane assembly and extending radially outwardly, wherein the at least one first radially projecting portion is circumferentially spaced apart from the at least one second radially projecting portion in a neutral position of the first seal so as to allow the first and second vane assemblies to move circumferentially toward each other, and wherein, in response to the first and second vane assemblies moving circumferentially away from each other, the at least one first radially projecting portion engages the at least one second radially projecting portion so as to delimit movement of the first and second vane assemblies circumferentially away from each other.

10. The gas turbine engine of claim 1, wherein the main body of the first seal is formed at least partially as a spring configured to expand and contract during thermal expansion of the first and second vane assemblies.

11. A gas turbine engine comprising:
a first engine component configured to interact with gases flowing through the gas turbine engine and a second engine component arranged adjacent to the first engine component and configured to interact with the gases flowing through the gas turbine engine, wherein the first engine component includes a first groove formed in a first surface facing the second engine component, the second engine component includes a second groove formed in a second surface facing the first engine component, and
a first seal arranged between the first and second engine components, the first seal having a first end arranged in the first groove and a second end located in the second groove, the first seal configured to block the gases flowing over the first and second engine components from passing through a gap between the first and second engine components,
wherein the first seal includes a main body extending between the first and second engine components, a first projecting portion having a first rounded shape when viewed along a central axis of the gas turbine engine and arranged within a corresponding first projection receiving recess formed in the first groove, and a second projecting portion having a second rounded shape when viewed along the central axis and arranged within a corresponding second projection receiving recess formed in the second groove so as to allow for thermal expansion of the first and second engine components, and wherein the first engine component, the second engine component, and the first seal are formed in a single fabrication operation,
wherein the first projection receiving recess has a third rounded shape when viewed along the central axis that matches the first rounded shape of the first projecting portion and the second projection receiving recess has a fourth rounded shape when viewed along the central axis that matches the second rounded shape of the second projecting portion.

12. The gas turbine engine of claim 11, wherein the first engine component, the second engine component, and the first seal are formed integrally as a single, monolithic component via additive layer manufacturing.

13. The gas turbine engine of claim 11, wherein the first projecting portion is spaced apart from an inner surface of the first projection receiving recess in a neutral position of the first seal so as to allow the first and second engine components to move circumferentially toward each other, and wherein, in response to the first and second engine components moving circumferentially away from each other, the first projecting portion engages the inner surface so as to delimit movement of the first and second engine components circumferentially away from each other.

14-16. (canceled)

17. A method comprising:
additively manufacturing a first engine component of a gas turbine engine, a second engine component of the gas turbine engine arranged adjacent to the first engine component, and a first seal arranged between the first and second engine components such that the first and second engine components and the first seal are formed in a single fabrication operation, the additive manufacturing of the first and second engine components and the first seal including:
forming a first groove in the first engine component in a first side wall of the first engine component that opens toward the second engine component,
forming a second groove in the second engine component in a second side wall of the second engine component that opens toward the first engine component, and
forming a first end of the first seal in the first groove and a second end of the first seal opposite the first end in the second groove,
wherein the first seal includes a main body extending between the first and second engine components, a first projecting portion arranged within a corresponding first projection receiving recess formed in the first groove, and a second projecting portion arranged within a corresponding second projection receiving recess formed in the second groove so as to allow for thermal expansion of the first and second engine components while delimiting movement of the first and second vane engine components away from each other, the first and second projecting portions each defining a first radial thickness that is greater than a second radial thickness of the main body.

18. The method of claim 17, wherein the first projecting portion is additively manufactured so as to be spaced apart from an inner surface of the first projection receiving recess in a neutral position of the first seal so as to allow the first and second engine components to move toward each other, and wherein, in response to the first and second engine components moving away from each other, the first projecting portion engages the inner surface so as to delimit movement of the first and second engine components away from each other.

19. The method of claim 18, further comprising
determining distances that the first and second engine components can move relative to each other due to one or more of thermal expansion or thermal contraction when arranged in the gas turbine engine and subject to thermal stresses, and
additively manufacturing the first projection receiving recess such that a distance between the inner surface of the first projection receiving recess and the first projecting portion allows the first and second engine components to move the determined distances during thermal expansion of the first and second engine components.

20. The method of claim 19, wherein the first and second engine components are circumferentially spaced apart from each other, wherein the first projecting portion includes a first projection surface that faces at least partially in a first circumferential direction and a second projection surface that faces at least partially in a second circumferential direction opposite the first circumferential direction, wherein the inner surface of the first projection receiving recess includes a first inner surface adjacent to and spaced apart from the first projection surface and a second inner surface adjacent to and spaced apart from the second projection surface in the neutral position of the first seal, and wherein the circumferential distances include a distance between the first projection surface and the first inner surface and a distance between the second projection surface and the second inner surface.

21. The gas turbine engine of claim 1, further comprising one or more removable standoffs extending between and coupled to the first seal and one of the first vane platform and the second vane platform to support the first seal relative to the one of the first vane platform and the second vane platform.

22. The gas turbine engine of claim 1, wherein the first vane assembly, the second vane assembly, and the first seal are each formed of the same material.

23. The gas turbine engine of claim 1, wherein the first projecting portion and the second projecting portion each have a rounded shape.

24. The gas turbine engine of claim 11, further comprising one or more removable standoffs extending between and coupled to the first seal and one of the first engine component and the second engine component to support the first seal relative to the one of the first engine component and the second engine component.

25. The gas turbine engine of claim 11, wherein the first vane assembly, the second vane assembly, and the first seal are each formed of the same material.
